(19) United States
(12) Patent Application Publication
(10) Pub. No.: US 2023/0094709 A1
(43) Pub. Date: Mar. 30, 2023

(54) WIRELESS COMMUNICATION METHOD, APPARATUS, AND SYSTEM

(71) Applicant: HUAWEI TECHNOLOGIES CO., LTD., Shenzhen (CN)

(72) Inventors: Mingzeng Dai, Shenzhen (CN); Jianjun Wu, Shanghai (CN); Chenghui Peng, Shanghai (CN)

(21) Appl. No.: 18/075,245

(22) Filed: Dec. 5, 2022

Related U.S. Application Data
(63) Continuation of application No. PCT/CN2021/097661, filed on Jun. 1, 2021.

(30) Foreign Application Priority Data
Jun. 5, 2020 (CN) 202010506251.2

(51) Int. Cl. H04W 76/10; H04W 68/00

(52) U.S. Cl. CPC H04W 76/10; H04W 68/00

(57) ABSTRACT

Embodiments of this application provide a wireless communication method, apparatus, and system. The method includes: receiving, by a first entity, a first message sent by a second entity, where the first message carries configuration information of a sub-task, and the first entity and the second entity are entities in a radio access network; sending the configuration information of the sub-task to a terminal device; receiving a task execution result fed back by the terminal device; and sending the task execution result to the second entity. Because the sub-task is executed by the terminal device, a problem of a single communication link in a related technology can be avoided, to implement technical effects of communication flexibility and diversity. In addition, different sub-tasks are executed by different terminal devices, so that efficiency of completing a target task can be improved, and resources are appropriately used.

### CROSS-REFERENCE TO RELATED APPLICATIONS

This application is a continuation of International Application No. PCT/CN2021/097661, filed on Jun. 1, 2021, which claims priority to Chinese Patent Application No. 202010506251.2, filed on Jun. 5, 2020. The disclosures of the aforementioned applications are hereby incorporated by reference in their entireties.

### TECHNICAL FIELD

This application relates to the field of communication technologies, and in particular, to a wireless communication method, an apparatus, and a system.

### BACKGROUND

With development of a network, intensive deployment of a high-frequency station such as a millimeter-wave station, popularization of a diversified terminal, and development of network native intelligence, a future network is a real-time and full-scene sensing network. A deep edge computing capability sinks to the inside of a wireless network, and all nodes in the wireless network such as user equipment (user equipment, UE), an active antenna unit (Active Antenna Unit, AAU)/a radio remote unit (Radio Remote Unit, RRU), and a building baseband unit (Building Baseband Unit, BBU) have a computing capability, and are edge computing nodes. To complete a computing task, all the nodes need to cooperatively complete the computing task.

An existing radio access network (Radio Access Network, RAN) and an existing communication mode are developed based on a conventional voice service. A communication mode of a single point-to-point link exists between a network device and a terminal device. As a result, a single communication link and a low cooperation capability occur.

### SUMMARY

To resolve the foregoing technical problem, embodiments of this application provide a wireless communication method, an apparatus, and a system.

According to a first aspect, an embodiment of this application provides a wireless communication method, where the method is applied to a first entity, and the method includes:

receiving a first message sent by a second entity, where the first message carries configuration information of a sub-task, and the first entity and the second entity are entities in a radio access network;

sending the configuration information of the sub-task to a terminal device;

receiving a task execution result fed back by the terminal device; and

sending the task execution result to the second entity.

The first entity may be a user control plane logical entity, the second entity may be a task control plane logical entity, and the first entity and the second entity may be entities in the radio access network.

In other words, in this embodiment of this application, the radio access network is improved by introducing the first entity and the second entity, the first entity sends, to the terminal device, the configuration information that is of the sub-task and that is sent by the second entity, and the first entity sends, to the first entity, the task execution result fed back by the terminal device.

Because the sub-task may be executed by the terminal device, a problem of a single communication link in a related technology can be avoided, to implement technical effects of communication flexibility and diversity. In addition, different sub-tasks may be executed by different terminal devices. Therefore, efficiency of completing a target task can be improved, and technical effect of appropriately using resources can be implemented.

In some embodiments, the first message further carries a signaling link transmission policy and/or a data channel transmission policy, and the sending the configuration information of the sub-task to a terminal device includes:

sending the configuration information of the sub-task to the terminal device based on the signaling link transmission policy and/or the data channel transmission policy.

In other words, the first message may carry one or more transmission policies, and the first entity may transmit the configuration information of the sub-task based on the one or more transmission policies. Certainly, the first entity may transmit the task execution result based on the one or more transmission policies.

In this embodiment of this application, information may be transmitted by selecting a plurality of transmission policies. This may implement technical effects of improving information transmission flexibility and diversity.

In some embodiments, if the first message carries the signaling link transmission policy, the method further includes:

sending, to the terminal device, a prompt message for establishing a radio resource control link;

receiving a radio resource control establishment request message fed back by the terminal device based on the prompt message; and

establishing a signaling link with the terminal device based on the radio resource control establishment request message.

In some embodiments, the prompt message includes a paging message that carries a type of the sub-task.

In other words, the signaling link between the first entity and the terminal device may be established in different manners based on a service requirement (for example, a requirement of a mobile originated service or a mobile terminated service). One manner is to directly establish the signaling link between the first entity and the terminal device (for example, when the service requirement is the requirement of the mobile originated service), and another manner is to establish the signaling link between the first entity and the terminal device by using the paging message (for example, when the service requirement is the requirement of the mobile terminated service).

In some embodiments, the paging message includes a first cause value, and the first cause value indicates the type of the sub-task.

In some embodiments, the radio resource control establishment request message carries a second cause value, and the establishing a signaling link with the terminal device based on the radio resource control establishment request message includes:

determining a link type based on the second cause value; and

establishing the signaling link based on the link type.

The first cause value may be the same as or different from the second cause value.

In other words, in this embodiment of this application, signaling links of different link types may be established based on different second cause values. Different first cause values indicate types of different sub-tasks. Therefore, signaling links of different link types may be established based on types of different sub-tasks and different second cause values, to implement technical effects of diversity and flexibility in signaling link establishment.

In some embodiments, the signaling link includes a data radio bearer link and/or a signaling radio bearer link.

In some embodiments, if the first message carries the data channel transmission policy, the method further includes:

establishing a data channel between the second entity and the terminal device.

In some embodiments, the data channel includes a second data channel between the terminal device and a third entity and a first data channel between the third entity and the second entity, and the third entity is an entity in the radio access network.

In some embodiments, the first data channel between the third entity and the second entity is used to transmit at least the task execution result fed back by the terminal device.

In other words, the first data channel between the third entity and the second entity is a shared data channel, and may be used to transmit task execution results fed back by different terminal devices. Because the first data channel between the third entity and the second entity is a shared data channel, technical effect of improving resource utilization appropriateness may be implemented.

In some embodiments, the second data channel is a data radio bearer link.

In some embodiments, the terminal device is selected by the second entity based on attribute information of each terminal device, and the attribute information includes running state information and/or location information.

In this embodiment of this application, the terminal device that executes the sub-task is selected by using the attribute information of each terminal device. This may implement technical effects of improving reliability and efficiency of executing the sub-task.

In some embodiments, the first message is generated by the second entity based on a second message sent by the terminal device, and the second message carries a target task.

In other words, a terminal device that sends the target task may also be a terminal device that participates in executing the sub-task. Therefore, technical effect of appropriately using resources may be implemented

In some embodiments, that the first message carries the signaling link transmission policy and/or the data channel transmission policy is determined by the second entity based on attribute information of the target task.

In other words, the transmission policy may be determined based on the attribute information of the target task, to implement technical effect of ensuring that the target task is efficiently and accurately completed.

According to a second aspect, an embodiment of this application further provides a wireless communication method, where the method is applied to a second entity, and the method includes:

obtaining a to-be-processed target task;

generating a first message based on the target task, where the first message carries configuration information of a sub-task;

sending the first message to a first entity, where the first entity and the second entity are entities in a radio access network; and

receiving a task execution result fed back by the first entity.

In other words, if the first entity obtains the target task, the first entity may analyze and split the target task, generate the first message that carries the configuration information of the sub-task, and send the first message to the first entity. The first entity may send the first message to a terminal device. The terminal device may execute the sub-task based on the configuration information of the sub-task, generate the task execution result, and send the task execution result to the first entity. The first entity may send the task execution result to the second entity.

In some embodiments, the first message further carries a signaling link transmission policy and/or a data channel transmission policy.

In some embodiments, the signaling link transmission policy indicates the first entity to establish a signaling link between the first entity and a terminal device based on a prompt message of a radio resource control link.

In some embodiments, the prompt message includes a paging message that carries a type of the sub-task.

In some embodiments, the paging message includes a first cause value, and the first cause value indicates the type of the sub-task.

In some embodiments, the signaling link is established by the first entity based on a link type determined based on a second cause value.

In some embodiments, the signaling link includes a data radio bearer link and/or a signaling radio bearer link.

In some embodiments, the data channel transmission policy indicates the first entity to establish a data channel between the second entity and the terminal device.

In some embodiments, the data channel includes a second data channel between the terminal device and a third entity and a first data channel between the third entity and the second entity, and the third entity is an entity in the radio access network.

In some embodiments, the first data channel between the third entity and the second entity is used to transmit at least the task execution result fed back by the terminal device.

In some embodiments, the second data channel is a data radio bearer link.

In some embodiments, the terminal device is selected by the second entity based on attribute information of each terminal device, and the attribute information includes running state information and/or location information.

In some embodiments, the first message is generated by the first entity based on a second message sent by the terminal device, and the second message carries the target task.

In some embodiments, that the first message carries the signaling link transmission policy and/or the data channel transmission policy is determined based on attribute information of the target task.

According to a third aspect, an embodiment of this application further provides a wireless communication method, where the method is applied to a terminal device, and the method includes:

receiving configuration information that is of a sub-task and that is sent by a first entity, where the first entity is an entity in a radio access network;

executing the sub-task based on the configuration information of the sub-task to generate a task execution result; and

sending the task execution result to the first entity.

In some embodiments, the configuration information of the sub-task is sent by the first entity based on a signaling link transmission policy and/or a data channel transmission policy that are/is carried in a first message.

In some embodiments, if the first message carries the signaling link transmission policy, the method further includes:

receiving a prompt message that is for establishing a radio resource control link and that is sent by the first entity;

generating a radio resource control establishment request message based on the prompt message; and

establishing a signaling link with the first entity based on the radio resource control establishment request message.

In some embodiments, the prompt message includes a paging message that carries a type of the sub-task.

In some embodiments, the paging message includes a first cause value, and the first cause value indicates the type of the sub-task.

In some embodiments, the radio resource control establishment request message carries a second cause value.

In some embodiments, the signaling link includes a data radio bearer link and/or a signaling radio bearer link.

In some embodiments, if the first message carries the data channel transmission policy, the data channel transmission policy indicates that a data channel that is between the terminal device and a second entity and that is established by the first entity is used to transmit the configuration information of the sub-task and the task execution result, and the second entity is an entity in the radio access network.

In some embodiments, the data channel includes a second data channel between the terminal device and a third entity and a first data channel between the third entity and the second entity, and the third entity is an entity in the radio access network.

In some embodiments, the task execution result and an execution result of another sub-task are transmitted by using the same first data channel between the third entity and the second entity.

In some embodiments, the second data channel is a data radio bearer link.

In some embodiments, the terminal device is selected by the second entity based on attribute information of each terminal device, and the attribute information includes running state information and/or location information.

In some embodiments, the first message is generated by the second entity based on a second message sent by the terminal device, and the second message carries a target task.

In some embodiments, that the first message carries the signaling link transmission policy and/or the data channel transmission policy is determined based on attribute information of the target task.

According to another aspect of embodiments of this application, an embodiment of this application further provides a computer storage medium, where the computer storage medium stores computer instructions, and when the computer instructions are run by a processor, the method in any one of the foregoing embodiments is performed.

According to a fourth aspect, an embodiment of this application further provides a user control plane apparatus, where the user control plane apparatus may be the first entity in any one of the foregoing embodiments, and includes a processor, configured to execute computer instructions stored in a memory, and when the computer instructions are executed, the user control plane apparatus is enabled to perform the method applied to the first entity in the foregoing embodiments.

According to a fifth aspect, an embodiment of this application further provides a task control plane apparatus, where the task control plane apparatus may be the second entity in any one of the foregoing embodiments, and includes a processor, configured to execute computer instructions stored in a memory, and when the computer instructions are executed, the task control plane apparatus is enabled to perform the method applied to the second entity in the foregoing embodiments.

According to a sixth aspect, an embodiment of this application further provides a terminal device, including a processor, configured to execute computer instructions stored in a memory, where when the computer instructions are executed, the terminal device is enabled to perform the method applied to the terminal device in the foregoing embodiments.

According to a seventh aspect, an embodiment of this application further provides a radio access network device, including a central unit and a distribution unit, and further including:

the user control plane apparatus described in the foregoing embodiments; and

the task control plane apparatus described in the foregoing embodiments.

According to another aspect of embodiments of this application, an embodiment of this application further provides a wireless communication system, where the system includes:

the terminal device described in the foregoing embodiments; and

the radio access network device described in the foregoing embodiments.

According to an eighth aspect, an embodiment of this application further provides a computer program product, where when the computer program product runs on a processor, the method in any one of the foregoing embodiments is performed.

According to a ninth aspect, an embodiment of this application further provides a user control plane apparatus, where the user control plane apparatus includes:

a first receiving module, configured to receive a first message sent by a second entity, where the first message carries configuration information of a sub-task, and the first entity and the second entity are entities in a radio access network; and a first sending module, configured to send the configuration information of the sub-task to a terminal device, where the first receiving module is configured to receive a task execution result fed back by the terminal device; and the first sending module is configured to send the task execution result to the second entity.

In some embodiments, the first message further carries a signaling link transmission policy and/or a data channel transmission policy, and the first sending module is configured to send the configuration information of the sub-task to the terminal device based on the signaling link transmission policy and/or the data channel transmission policy.

In some embodiments, if the first message carries the signaling link transmission policy, the user control plane apparatus further includes:

the first sending module, configured to send, to the terminal device, a prompt message for establishing a radio resource control link;

the first receiving module, configured to receive a radio resource control establishment request message fed back by the terminal device based on the prompt message;

and a first processing module, configured to establish a signaling link with the terminal device based on the radio resource control establishment request message.

In some embodiments, the prompt message includes a paging message that carries a type of the sub-task.

In some embodiments, the paging message includes a first cause value, and the first cause value indicates the type of the sub-task.

In some embodiments, the radio resource control establishment request message carries a second cause value, and the first processing module is configured to: determine a link type based on the second cause value, and establish the signaling link based on the link type.

In some embodiments, the signaling link includes a data radio bearer link and/or a signaling radio bearer link.

In some embodiments, if the first message carries the data channel transmission policy, the first processing module is configured to establish a data channel between the second entity and the terminal device.

In some embodiments, the data channel includes a second data channel between the terminal device and a third entity and a first data channel between the third entity and the second entity, and the third entity is an entity in the radio access network.

In some embodiments, the first data channel between the third entity and the second entity is used to transmit at least the task execution result fed back by the terminal device.

In some embodiments, the second data channel is a data radio bearer link.

In some embodiments, the terminal device is selected by the second entity based on attribute information of each terminal device, and the attribute information includes running state information and/or location information.

In some embodiments, the first message is generated by the second entity based on a second message sent by the terminal device, and the second message carries a target task.

In some embodiments, that the first message carries the signaling link transmission policy and/or the data channel transmission policy is determined by the second entity based on attribute information of the target task.

According to a tenth aspect, an embodiment of this application further provides a task control plane apparatus, where the task control plane apparatus includes:

an obtaining module, configured to obtain a to-be-processed target task;

a second processing module, configured to generate a first message based on the target task, where the first message carries configuration information of a sub-task;

a second sending module, configured to send the first message to a first entity, where the first entity and the second entity are entities in a radio access network; and

a second receiving module, configured to receive a task execution result fed back by the first entity.

In some embodiments, the first message further carries a signaling link transmission policy and/or a data channel transmission policy.

In some embodiments, the signaling link transmission policy indicates the first entity to establish a signaling link between the first entity and a terminal device based on a prompt message of a radio resource control link.

In some embodiments, the prompt message includes a paging message that carries a type of the sub-task.

In some embodiments, the paging message includes a first cause value, and the first cause value indicates the type of the sub-task.

In some embodiments, the signaling link is established by the first entity based on a link type determined based on a second cause value.

In some embodiments, the signaling link includes a data radio bearer link and/or a signaling radio bearer link.

In some embodiments, the data channel transmission policy indicates the first entity to establish a data channel between the second entity and the terminal device.

In some embodiments, the data channel includes a second data channel between the terminal device and a third entity and a first data channel between the third entity and the second entity, and the third entity is an entity in the radio access network.

In some embodiments, the first data channel between the third entity and the second entity is used to transmit at least the task execution result fed back by the terminal device.

In some embodiments, the second data channel is a data radio bearer link.

In some embodiments, the terminal device is selected by the second entity based on attribute information of each terminal device, and the attribute information includes running state information and/or location information.

In some embodiments, the first message is generated by the first entity based on a second message sent by the terminal device, and the second message carries the target task.

In some embodiments, that the first message carries the signaling link transmission policy and/or the data channel transmission policy is determined based on attribute information of the target task.

According to an eleventh aspect, an embodiment of this application further provides a terminal device, where the terminal device includes:

a third receiving module, configured to receive configuration information that is of a sub-task and that is sent by a first entity, where the first entity is an entity in a radio access network;

a third processing module, configured to execute the sub-task based on the configuration information of the sub-task to generate a task execution result; and

a third sending module, configured to send the task execution result to the first entity.

In some embodiments, the configuration information of the sub-task is sent by the first entity based on a signaling link transmission policy and/or a data channel transmission policy that are/is carried in a first message.

In some embodiments, if the first message carries the signaling link transmission policy, the third receiving module is configured to receive a prompt message that is for establishing a radio resource control link and that is sent by the first entity; and the third processing module is configured to: generate a radio resource control establishment request message based on the prompt message, and establish a signaling link with the first entity based on the radio resource control establishment request message.

In some embodiments, the prompt message includes a paging message that carries a type of the sub-task.

In some embodiments, the paging message includes a first cause value, and the first cause value indicates the type of the sub-task.

In some embodiments, the radio resource control establishment request message carries a second cause value.

In some embodiments, the signaling link includes a data radio bearer link and/or a signaling radio bearer link.

In some embodiments, if the first message carries the data channel transmission policy, the data channel transmission policy indicates that a data channel that is between the terminal device and a second entity and that is established by the first entity is used to transmit the configuration information of the sub-task and the task execution result, and the second entity is an entity in the radio access network.

In some embodiments, the data channel includes a second data channel between the terminal device and a third entity and a first data channel between the third entity and the second entity, and the third entity is an entity in the radio access network.

In some embodiments, the task execution result and an execution result of another sub-task are transmitted by using the same first data channel between the third entity and the second entity.

In some embodiments, the second data channel is a data radio bearer link.

In some embodiments, the terminal device is selected by the second entity based on attribute information of each terminal device, and the attribute information includes running state information and/or location information.

In some embodiments, the first message is generated by the second entity based on a second message sent by the terminal device, and the second message carries a target task.

In some embodiments, that the first message carries the signaling link transmission policy and/or the data channel transmission policy is determined based on attribute information of the target task.

### BRIEF DESCRIPTION OF DRAWINGS

The accompanying drawings are used for a better understanding of embodiments of this application, and do not constitute a limitation on this application.

FIG. 1 is a schematic diagram of an application scenario of a wireless communication method according to this application;

FIG. 2 is a schematic diagram of another application scenario of a wireless communication method according to this application;

FIG. 3 is a schematic diagram of a framework of a radio access network in a conventional technology;

FIG. 4 is a schematic diagram of a framework of a protocol stack of a radio access network in a conventional technology;

FIG. 5 is a schematic diagram of a framework of a RAN according to an embodiment of this application;

FIG. 6 is a schematic diagram of a protocol stack corresponding to a control plane according to an embodiment of this application;

FIG. 7 is a schematic diagram of a protocol stack corresponding to a user plane according to an embodiment of this application;

FIG. 8 is a schematic diagram of a format of configuration information of a sub-task according to an embodiment of this application;

FIG. 9 is a schematic flowchart of a wireless communication method according to an embodiment of this application;

FIG. 10 is a schematic flowchart of a wireless communication method according to another embodiment of this application;

FIG. 11 is a schematic interaction diagram of a wireless communication method according to an embodiment of this application;

FIG. 12A and FIG. 12B are a schematic interaction diagram of a wireless communication method according to an embodiment of this application;

FIG. 13A to FIG. 13C are a schematic interaction diagram of a wireless communication method according to an embodiment of this application;

FIG. 14 is a schematic flowchart of a wireless communication method according to another embodiment of this application;

FIG. 15 is a schematic flowchart of a wireless communication method according to another embodiment of this application;

FIG. 16 is a schematic diagram of a terminal device according to an embodiment of this application;

FIG. 17 is a schematic diagram of a user control plane apparatus according to an embodiment of this application;

FIG. 18 is a schematic diagram of a task control plane apparatus according to an embodiment of this application;

FIG. 19 is a schematic diagram of a terminal device according to an embodiment of this application; and

FIG. 20 is a schematic diagram of an apparatus according to an embodiment of this application.

### DESCRIPTION OF EMBODIMENTS

Example embodiments are described in detail herein, and examples of the example embodiments are presented in the accompanying drawings. When the following description relates to the accompanying drawings, unless specified otherwise, same numbers in different accompanying drawings represent a same or similar element. Implementations described in the following example embodiments do not represent all implementations consistent with this application. On the contrary, they are only examples of apparatuses and methods that are described in the appended claims in detail and that are consistent with some aspects of this application.

The term “and/or” in this specification describes only an association relationship for describing associated objects and represents that three relationships may exist. For example, A and/or B may represent the following three cases: Only A exists, both A and B exist, and only B exists.

In the description of embodiments of this application, unless otherwise stated, “a plurality of” means two or more than two. For example, a plurality of network devices mean two or more network devices, and a plurality of terminal devices mean two or more terminal devices.

Embodiments of this application provide a wireless communication method. The method may be applied to an application scenario including a terminal device and a network device, and the network device may be a radio access network (Radio Access Network, RAN) device.

In some embodiments, the method may be applied to an application scenario in which a single type of terminal device is combined with a single type of network device, that is, in the application scenario, there may be only one type of terminal device, and there may also be only one type of network device.

For example, the wireless communication method in embodiments of this application may be applied to an application scenario including a mobile terminal and a base station, and a quantity of mobile terminals and/or a quantity of base stations may be set based on a requirement.

Classification of a type of the terminal device and/or a type of the network device may be implemented based on a requirement, experience, and the like.

The terminal device is used as an example. The terminal device may be classified into a mobile terminal device and a fixed terminal device. The mobile terminal device may include a mobile phone, a desktop computer, a laptop computer, a tablet computer, a smartwatch, and the like. The fixed terminal device may include a server, a mainframe computer, an in-vehicle terminal, and the like.

It should be noted that the type of the terminal device in embodiments of this application is merely used as an example to indicate that different types of terminal devices may be classified, and cannot be understood as a limitation on classification of the type of the terminal device. For example, in some other embodiments, the desktop computer and the laptop computer may be classified into one type, or the desktop computer and the laptop computer may be classified into different types.

In some other embodiments, the method may alternatively be applied to an application scenario in which a single type of terminal device is combined with a plurality of types of network devices, that is, in the application scenario, there may be only one type of terminal device, but there may be a plurality of types of network devices.

For example, the wireless communication method in embodiments of this application may be applied to an application scenario including a mobile terminal, a base station, and a roadside unit (Road Side Unit, RSU).

In some other embodiments, the method may alternatively be applied to an application scenario in which a plurality of types of terminal devices are combined with a single type of network device, that is, in the application scenario, there may be a plurality of types of terminal devices, but there may be only one type of network device.

For example, the wireless communication method in embodiments of this application may be applied to an application scenario including a mobile terminal, an in-vehicle terminal, and a base station.

In some other embodiments, the method may alternatively be applied to an application scenario in which a plurality of types of terminal devices are combined with a plurality of types of network devices, that is, in the application scenario, there may be a plurality of types of terminal devices, and there may also be a plurality of types of network devices.

For example, the wireless communication method in embodiments of this application may be applied to an application scenario including a mobile terminal, an in-vehicle terminal, a base station, and a roadside unit.

It should be noted that the application scenario of the wireless communication method in embodiments of this application may be applied to different network standards, for example, a narrowband internet of things (Narrow Band-Internet of Things, NB-IoT) system, a long term evolution (Long Term Evolution, LTE) system, a Bluetooth system, a Wi-Fi system, three application scenarios of a 5G mobile communication system such as enhanced mobile broadband (enhanced Mobile Broadband, eMBB), ultra-reliable and low latency communications (ultra-reliable low-latency communication, URLLC), enhanced machine type communication (enhanced Machine Type Communication, eMTC), and another communication system such as 6G.

Therefore, when the network device is a base station, the base station may be an evolved NodeB (Evolutional NodeB, eNB or eNodeB) in LTE, a relay station or an access point, a gNodeB (gNB) in a 5G network, a satellite, or a network device that has a base station function in device-to-device (Device-to-Device, D2D) communication, vehicle-to-everything (Vehicle-to-X, V2X) communication, machine-to-machine (Machine-to-Machine, M2M) communication, and various types of future possible communication. This is not limited in the present invention.

The terminal device may include various handheld devices, in-vehicle devices, telematics boxes (Telematics BOX, T-Box), domain controllers (Domain Controller, DC), multi-domain controllers (Multi-Domain Controller, MDC), on-board units (On board Unit, OBU), internet of vehicles chips, wearable devices, or computing devices that have a wireless communication function, or another processing device connected to a wireless modem.

Specifically, the terminal device may be a mobile terminal such as a mobile phone (or referred to as a “cellular” phone) and a computer with a mobile terminal, for example, may be a portable, pocket-sized, handheld, computer-built-in, or in-vehicle mobile apparatus that exchanges voice and/or data with a radio access network. Alternatively, the terminal device may be a device such as a personal communications service (Personal Communication Service, PCS) phone, a cordless phone, a session initiation protocol (Session Initiation Protocol, SIP) phone, a wireless local loop (Wireless Local Loop, WLL) station, a personal digital assistant (Personal Digital Assistant, PDA), a tablet computer, a wireless modem (modem), a handset (handset) device, a laptop computer (laptop computer), and a machine type communication (Machine Type Communication, MTC) terminal. Alternatively, the terminal device may be referred to as a system, a subscriber unit (Subscriber Unit), a subscriber station (Subscriber Station), a mobile station (Mobile Station), a mobile (Mobile) station, a remote station (Remote Station), a remote terminal (Remote Terminal), an access terminal (Access Terminal), a user terminal (User Terminal), a user agent (User Agent), user equipment (User Device or User Equipment), and the like. This is not limited herein.

It should be noted that the network device and the terminal device are relative concepts. In some embodiments, the wireless communication method may be applied to a plurality of network devices, or may be applied to a plurality of terminal devices. In addition, in some embodiments, some network devices may be used as terminal devices, some terminal devices may be used as network devices, and a specific framework of an application scenario may be configured based on a requirement, experience, and a test. This is not limited in embodiments of this application.

An application scenario in which one type of terminal device is combined with one type of network device is used as an example to describe the application scenario of the wireless communication method in embodiments of this application.

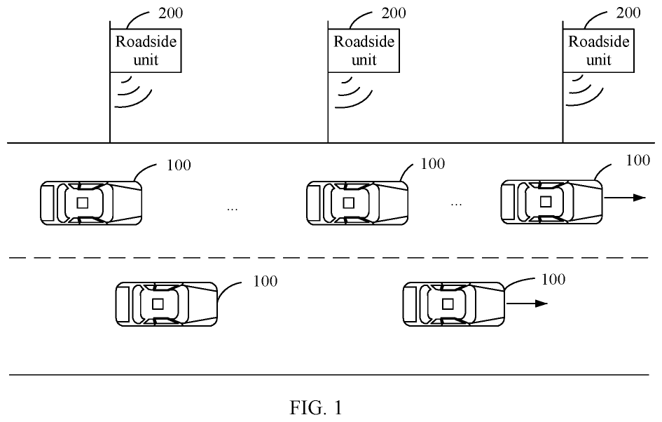

FIG. 1 is a schematic diagram of an application scenario of a wireless communication method according to an embodiment of this application.

In the application scenario shown in FIG. 1, a terminal device may be an in-vehicle terminal (not shown in FIG. 1) disposed on a vehicle 100. In addition, as shown in FIG. 1, the vehicle 100 travels on a road, and there may be a plurality of vehicles 100, that is, there may be a plurality of in-vehicle terminals. A network device is a roadside unit 200 disposed on two sides of the road. In addition, as shown in FIG. 1, there may be a plurality of roadside units 200.

When the wireless communication method in this embodiment of this application is applied to the application scenario shown in FIG. 1, the roadside unit 200 may be a RAN device, and the RAN includes a plurality of entities such as a central unit (Central Unit, CU) and a distributed unit (Distributed Unit, DU). For descriptions of the central unit and the distributed unit, refer to a related technology. Details are not described herein. However, in this embodiment of this application, on the basis of the related technology, at least two entities are further introduced to the RAN, namely, a first entity and a second entity that are specifically described below. Details are not described herein.

Specifically, when the wireless communication method in this embodiment of this application is applied to the application scenario shown in FIG. 1, an in-vehicle terminal (which is briefly referred to as any in-vehicle terminal) of any vehicle may send a request message to a roadside unit. The request message may carry a task requirement. The task requirement may be used to obtain an electronic map, road condition information, or the like of a road segment. The roadside unit may parse and split the task requirement in the request message, generate configuration information of a plurality of sub-tasks, and send the configuration information of the plurality of sub-tasks to in-vehicle terminals (which may include the in-vehicle terminal that is of the vehicle and that sends the request message) of a plurality of vehicles. The in-vehicle terminal of each vehicle executes the sub-task, and feeds back an execution result of sub-task corresponding to the in-vehicle terminal. The roadside unit may integrate the task execution results to obtain the electronic map or the road condition information, and feed back the electronic map or the road condition information to the in-vehicle terminal that is of the vehicle and that sends the request message. Certainly, the roadside unit may feed back the task execution results to the in-vehicle terminal that is of the vehicle and that sends the request message, and the in-vehicle terminal that is of the vehicle and that sends the request message determines the electronic map or the road condition information based on the task execution results.

The roadside unit is the RAN device to which the first entity and the second entity are introduced. Therefore, the second entity may parse and split the task requirement, and the first entity may perform information transmission (for example, transmission of the configuration information of the sub-task and the task execution result) between the first entity and the in-vehicle terminal that is of each vehicle and that executes a task. A specific implementation principle is described in detail below, and details are not described herein.

It should be noted that the application scenario shown in FIG. 1 is merely used as an example to describe the application scenario to which the wireless communication method in this embodiment of this application may be applied, and cannot be understood as a limitation on the application scenario of the wireless communication method in this embodiment of this application. For example, based on a service requirement, a composition element in FIG. 1 may be added or reduced adaptively, for example, based on a service requirement, a quantity of existing composition elements may be increased or decreased, for example, a quantity of in-vehicle terminals of vehicles and/or a quantity of roadside units are/is increased or decreased; or a new composition element may be added, for example, a base station and/or a mobile phone are/is added.

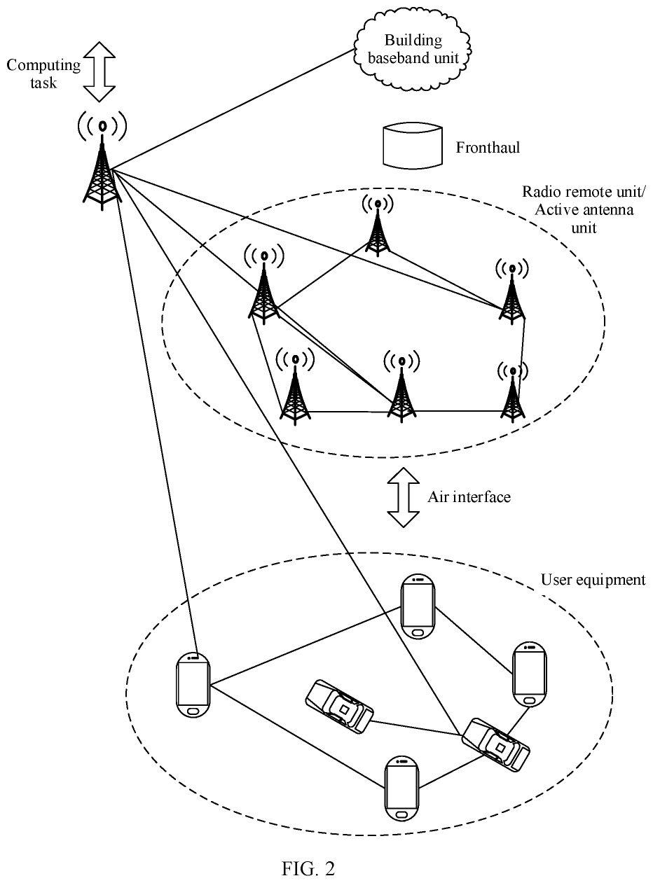

In some other embodiments, the wireless communication method in this embodiment of this application may be further used in an application scenario shown in FIG. 2.

In the application scenario shown in FIG. 2, an active antenna unit (Active Antenna Unit, AAU)/a radio remote unit (Radio Remote Unit, RRU), a building baseband unit (Building Baseband Unit, BBU), and user equipment (user equipment, UE) all have a computing capability, and may be used as a terminal device that cooperatively completes a computing task. An air interface (Air Interface) may be used to connect the RRU/AAU and the UE. Fronthaul (Front Haul) may be used to connect the BBU and the RRU.

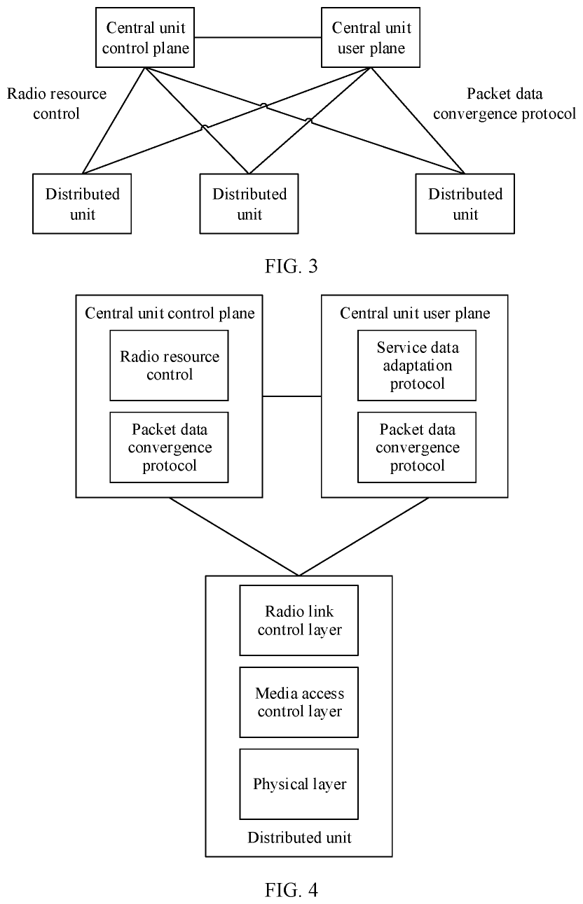

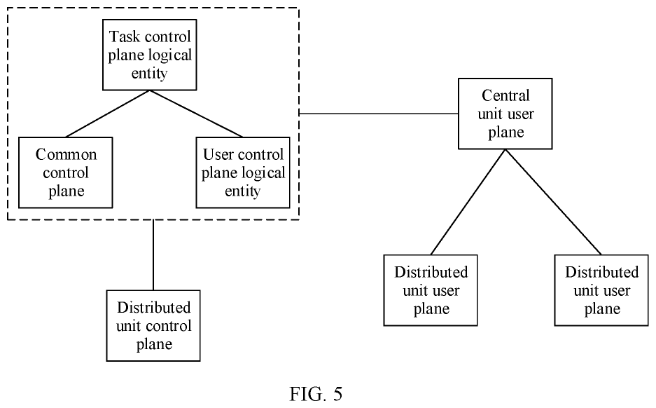

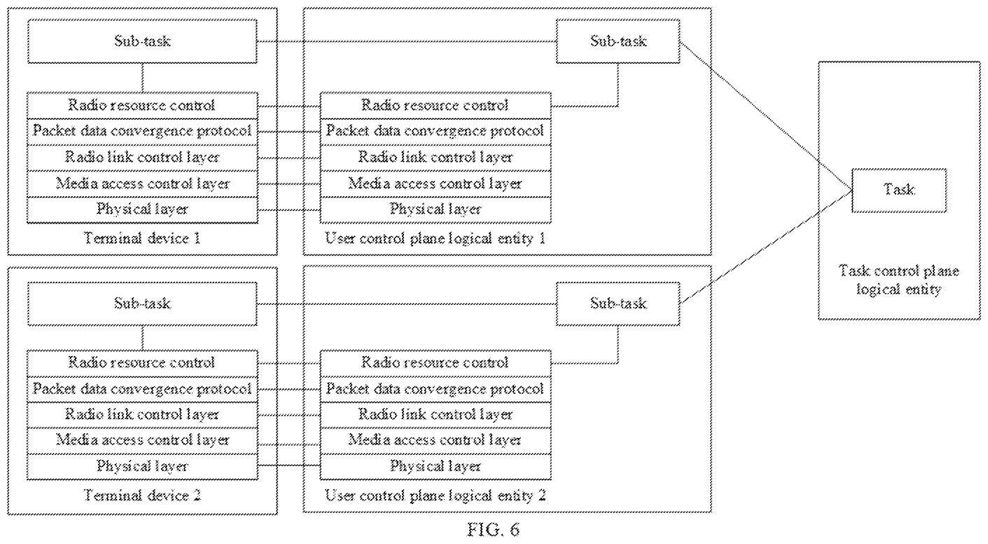

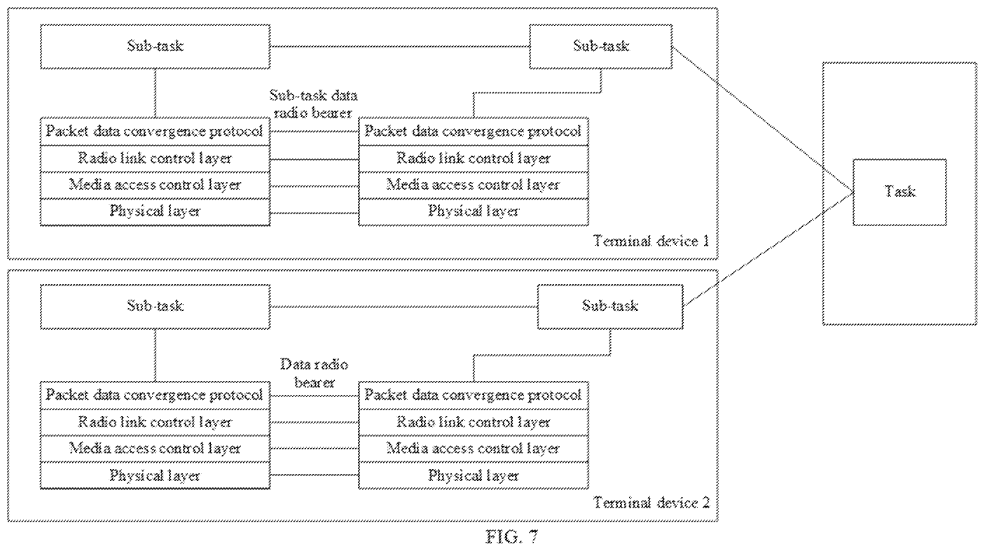

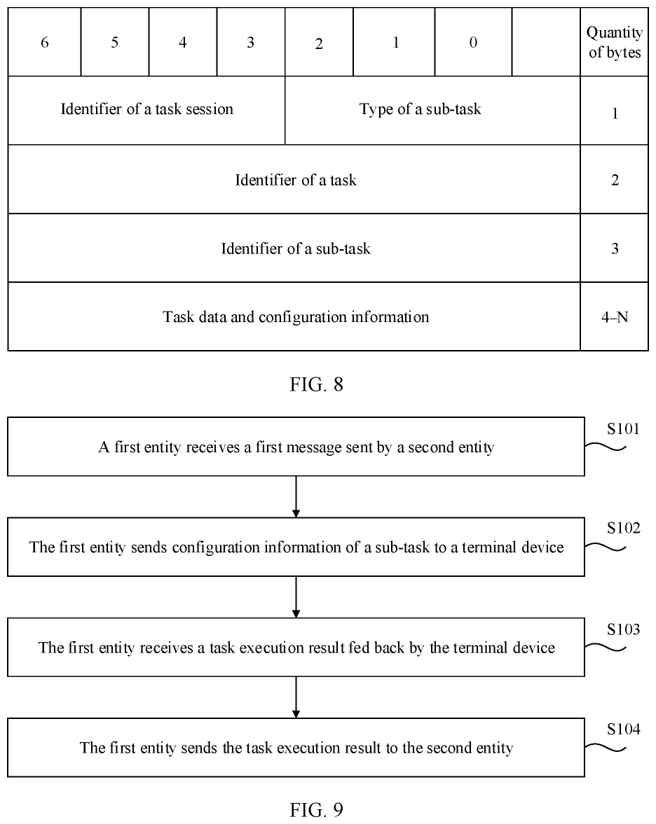

It may be learned from the foregoing descriptions of the application scenario that, on the basis of a related technology, in this embodiment of this application, a RAN is creatively improved. To enable a reader to clearly understand a difference between this embodiment of this application and the related technology, details are described with reference to FIG. 3, FIG. 4, FIG. 5, FIG. 6, FIG. 7, and FIG. 8.

FIG. 3 is a schematic diagram of a framework of a radio access network in a conventional technology.

It may be learned from FIG. 3 that, in the conventional technology, a RAN includes a plurality of entities such as a central unit (Central Unit, CU) and a distributed unit (Distributed Unit, DU). A function of the CU may be implemented by one entity or different entities. For example, the function of the CU may be further divided, for example, a control plane (CP) and a user plane (UP) are separated to obtain a CU control plane (CU-CP) and a CU user plane (CU-UP). For example, the CU-CP and the CU-UP may be implemented by different functional entities. The CU-CP and the CU-UP may be coupled to the DU to jointly implement a function of a network device (for example, a base station). In addition, the CU-CP is responsible for a control plane function, mainly including radio resource control (Radio Resource Control, RRC) and a packet data convergence protocol (Packet Data Convergence Protocol, PDCP).

FIG. 4 is a schematic diagram of a framework of a protocol stack of a radio access network in a conventional technology.

As shown in FIG. 4, the CU-CP mainly performs a control plane function. RRC and PDCP of the control plane are located in the CU-CP. The CU-UP mainly performs a user plane function. A service data adaptation protocol SDAP and a PDCP packet data convergence protocol layer of the user plane are located in the CU-UP. The CU-CP and the CU-UP are connected to each other by using an μl interface. The DU performs functions of a radio link control (radio link control, RLC) layer, a media access control (Media Access Control, MAC) layer, and a physical (physical, PHY) layer.

FIG. 5 is a schematic diagram of a framework of a RAN according to an embodiment of this application.

It may be learned from FIG. 3 and FIG. 5 that, on the basis of FIG. 3, in this embodiment of this application, the first entity and the second entity are introduced, and the first entity may be a user control plane logical entity (U-CP) shown in FIG. 5, and the second entity may be a task control plane logical entity (T-CP). It may be learned from FIG. 5 that, in some embodiments, a common control plane (C-CP) shown in FIG. 5 may be further introduced in this embodiment of this application.

The T-CP may be configured to: analyze and split a task of a service requirement of a terminal device to obtain a plurality of sub-tasks, generate configuration information of each sub-task, and send the configuration information of each sub-task to a plurality of U-CPs.

The U-CP may be configured to send configuration information of at least one sub-task to a corresponding terminal device.

The C-CP may be configured to be responsible for common control, such as a system information block (system information block, SIB) and a master information block (master information block, MIB).

It should be noted that the T-CP, the U-CP, and the C-CP may be three independent entities, or may be one integrated entity.

It may be learned from the foregoing example that the RAN may be divided into a control plane and a user plane. Therefore, on the basis of the RAN to which a new entity is introduced, a protocol stack of the RAN in this embodiment of this application may be considered from two aspects: One aspect is a protocol stack corresponding to the control plane, and the other aspect is a protocol stack corresponding to the user plane.

FIG. 6 is a schematic diagram of a protocol stack corresponding to a control plane according to an embodiment of this application.

As shown in FIG. 6, the T-CP may split a task task into two sub-tasks sub-task, and send configuration information of one sub-task to a U-CP1. The U-CP1 sends the configuration information of the sub-task to a terminal device 1 corresponding to the U-CP1, and the configuration information of the sub-task may be borne at an RRC layer. Specifically, the configuration information of the sub-task may be encapsulated into an RRC container (RRC Container).

Similarly, the T-CP may send configuration information of the other sub-task to a U-CP2. The U-CP2 sends the configuration information of the sub-task to a terminal device 2 corresponding to the U-CP2, and the configuration information of the sub-task may also be borne at an RRC layer. Specifically, the configuration information of the sub-task may also be encapsulated into an RRC Container.

FIG. 7 is a schematic diagram of a protocol stack corresponding to a user plane according to an embodiment of this application.

As shown in FIG. 7, the T-CP may split a task task session into two sub-tasks sub-session, and send configuration information of one sub-session to a terminal device 1. The configuration information of the sub-session may be borne on a user plane protocol stack. Specifically, the configuration information of the sub-session may be borne, for transmission, as user data at an air interface by using a user plane. As shown in FIG. 7, a task data radio bearer (data radio bearer, DRB) may be constructed, and the configuration information of the sub-session is transmitted by using the task DRB.

Similarly, the T-CP may send configuration information of the other sub-session to a terminal device 2. The configuration information of the sub-session may also be borne on a user plane protocol stack. Specifically, the configuration information of the sub-session may be borne, for transmission, as user data at an air interface by using a user plane. As shown in FIG. 7, a task DRB may be constructed, and the configuration information of the sub-session is transmitted by using the task DRB.

It should be noted that the foregoing example is merely used to describe a possible manner of transmitting information between the entities (for example, between the T-CP and the U-CP, between the T-CP and the UE, or the like) and a possible existence form of the protocol stack based on the terminal device, and cannot be understood as a limitation on the information transmission manner and a limitation on the protocol stack.

It may be learned from the foregoing example that the configuration information of the sub-task may be transmitted by using the control plane and/or the user plane. For a format of the configuration information of the sub-task, refer to FIG. 8.

As shown in FIG. 8, a quantity of bytes Number of OCts may be N. In addition, the last 4 bytes bits may represent an identifier of a task session, for example, a task session ID. The first 4 bytes bits may represent a type of a sub-task, for example, a task type. All the bits may represent an identifier of the task, for example, a task ID. All the bits may represent an identifier of the sub-task, for example, a sub-task ID. All the bits may represent task data and configuration information, for example, task data and configuration.

In the related technology, during application of the RAN, task allocation does not exist. Instead, when the network device receives a service request (for example, a request for obtaining an electronic map), the network device obtains the electronic map, and feeds back the electronic map to a terminal that sends the request.

However, because a communication mode of a single point-to-point link between the terminal device and the network device is used in the related technology, a problem of a single communication link exists.

With creative efforts, the inventor of this application obtains the invention concept of this application: Based on the RAN including the first entity and the second entity in this embodiment of this application, a plurality of terminal devices cooperate to complete a service requirement.

By using specific embodiments, the following describes in detail the technical solutions of this application and how to resolve the foregoing technical problem by using the technical solutions of this application. The following several specific embodiments may be combined with each other, and a same or similar concept or process may not be described repeatedly in some embodiments. The following describes embodiments of this application with reference to the accompanying drawings.

According to an aspect, an embodiment of this application provides a wireless communication method applicable to the foregoing application scenario, and the method is applied to a first entity.

FIG. 9 is a schematic flowchart of a wireless communication method according to an embodiment of this application.

As shown in FIG. 9, the method includes the following steps.

S101: The first entity receives a first message sent by a second entity, where the first message carries configuration information of a sub-task, and the first entity and the second entity are entities in a radio access network.

In other words, on the basis of a radio access network in a related technology, the first entity and the second entity are introduced in this embodiment of this application, and the wireless communication method described in S101 to S104 may be performed by the first entity.

Specifically, in some embodiments, the second entity may be a task control plane logical entity (T-CP), and the first entity may be a user control plane logical entity (U-CP).

It should be noted that an existence form and an existence manner of the first entity and/or an existence form and an existence manner of the second entity are not limited in this embodiment of this application. For example, the first entity and/or the second entity may be components having an actual form, or may be program products stored in another entity in the radio access network, and the first entity and the second entity may be two independent entities, or may be one integrated entity.

With reference to the application scenario shown in FIG. 1, this embodiment may be understood as follows: A roadside unit is a radio access network device, and the radio access network includes a central unit and a distribution unit, and also includes the first entity and the second entity. The first entity may send the first message to the second entity. The first message carries the configuration information of the sub-task.

The configuration information of the sub-task may be used to represent information related to the sub-task, for example, a type of the sub-task and content of the sub-task.

Specifically, the type of the sub-task may include a computing type, a perception type, a communication type, and the like. The content of the sub-task may be used to represent task information of the sub-task that needs to be executed, for example, the content of the sub-task may be obtaining an electronic map of a road segment.

For example, it may be learned from FIG. 8 that, when the type of the sub-task is the computing type, the first 4 bits of 8 bits may represent the computing type; the 8 bits may represent an identifier of the sub-computing task, to be distinguished from another sub-computing task; the 8 bits may represent an identifier of the computing type, to be distinguished from another type of task such as a task of a communication type; and the 8 bits may represent task data and configuration information, for example, the 8 bits represent obtaining an electronic map of a road segment.

S102: The first entity sends the configuration information of the sub-task to a terminal device.

It should be noted that there is a correspondence between the first entity and the terminal device, that is, it may be understood that the first entity may establish a connection to one or more terminal devices and communicate with the one or more terminal devices.

For example, in the application scenario shown in FIG. 1, the roadside unit may establish a connection to in-vehicle terminals of one or more vehicles and communicate with the in-vehicle terminals of the one or more vehicles. In addition, based on the application scenario shown in FIG. 1, due to a transmit/receive frequency of the roadside unit, a correspondence between the roadside unit and the in-vehicle terminal of the vehicle may be determined based on a distance between the roadside unit and the in-vehicle terminal of the vehicle. To be specific, the roadside unit may send the configuration information of the sub-task to an in-vehicle terminal of a vehicle in a range that the transmit/receive frequency of the roadside unit can cover.

S103: The first entity receives a task execution result fed back by the terminal device.

S104: The first entity sends the task execution result to the second entity.

It should be noted that the first entity sends the configuration information of the sub-task to the terminal device. The terminal device may execute the sub-task based on the configuration information of the sub-task, generate the task execution result, and feed back the task execution result to the first entity. The first entity may send, to the first entity, the task execution result fed back by the terminal device.

For example, in the application scenario shown in FIG. 1, the in-vehicle terminal of the vehicle executes the sub-task based on the configuration information of the sub-task, generates the task execution result, and feeds back the task execution result to the first entity. The first entity sends the task execution result to the second entity.

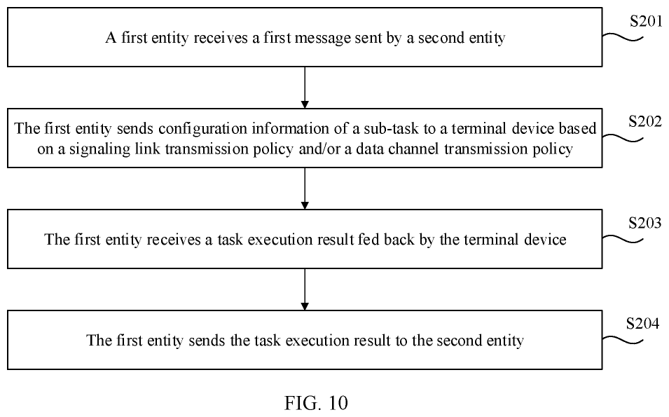

To enable a reader to understand technical details of embodiments of this application more clearly, for example, transmission of the configuration information of the sub-task and transmission of the task execution result, the wireless communication method in embodiments of this application is described in detail with reference to FIG. 10. FIG. 10 is a schematic flowchart of a wireless communication method according to another embodiment of this application.

As shown in FIG. 10, the method includes the following steps.

S201: The first entity receives a first message sent by a second entity, where the first message carries configuration information of a sub-task, and the first entity and the second entity are entities in a radio access network.

For descriptions of S201, refer to S101. Details are not described herein again.

S202: The first entity sends the configuration information of the sub-task to a terminal device based on a signaling link transmission policy and/or a data channel transmission policy, where the first message carries the signaling link transmission policy and/or the data channel transmission policy.

In other words, in this embodiment of this application, in addition to the configuration information of the sub-task, the first message may further carry the signaling link transmission policy and/or the data channel transmission policy. When the first message carries the signaling link transmission policy, the first entity may send the configuration information of the sub-task to the terminal device based on the signaling link transmission policy. When the first message carries the data channel transmission policy, the first entity may send the configuration information of the sub-task to the terminal device based on the data channel transmission policy. When the first message carries the signaling link transmission policy and the data channel transmission policy, the first entity may send the configuration information of the sub-task to the terminal device based on the signaling link transmission policy and the data channel transmission policy.

The signaling link transmission policy may indicate that the configuration information of the sub-task and/or a task execution result are/is transmitted by constructing a signaling link.

In a possible implementation, the signaling link includes a data radio bearer link and/or a signaling radio bearer link.

The data channel transmission policy may indicate that the configuration information of the sub-task and/or a task execution result are/is transmitted by constructing a data channel.

The terminal device may be selected by the second entity based on attribute information of each terminal device, and the attribute information may include at least running state information and/or location information.

In other words, the terminal device that executes the sub-task may be selected by the second entity from a plurality of terminal devices, and may be specifically selected based on respective attribute information of the plurality of terminal devices.

The running state information may be used to represent information related to running of the terminal device, for example, a working state or an idle state of the terminal device, or a related parameter in a working state of the terminal device.

The location information may be used to represent information related to a location of the terminal device, for example, coordinates of the terminal device in a world coordinate system.

In a possible implementation, the first message may be generated by the second entity based on a second message sent by the terminal device, and the second message may carry a target task.

In other words, the terminal device may generate the second message based on a service requirement, and send the second message to the second entity, and the second entity generates the first message based on the target task carried in the second message, and sends the first message to the second entity.

In a possible implementation, that the first message carries the signaling link transmission policy and/or the data channel transmission policy is determined by the second entity based on attribute information of the target task.

The attribute information of the target task may be used to represent at least one of a type, a size, and a priority of the target task.

In other words, the second entity may determine, based on the attribute information of the target task, whether the configuration information of the sub-task and/or the task execution result are/is transmitted by using one transmission policy or a plurality of transmission policies.

For example, when a type of the sub-task is a computing type or a perception type, the signaling link is established. When a type of the sub-task is a communication type, the data channel is established.

In a possible implementation, if the first message carries the signaling link transmission policy, the method in this embodiment of this application further includes a step of establishing the signaling link by the first entity, and the signaling link may be established in different manners based on different service requirements (for example, a requirement of a mobile originated service or a mobile terminated service).

For example, if the service requirement is the requirement of the mobile terminated service, the step of establishing the signaling link by the first entity may include:

S01: The first entity sends, to the terminal device, a prompt message for establishing a radio resource control link, where the prompt message includes a paging message, and the paging message carries the type of the sub-task.

In a possible implementation, the terminal device is a terminal device in an idle state. In other words, to improve reliability and efficiency of executing the target task, the terminal device to which the first entity sends the paging message is a terminal device in an idle state.

The type of the sub-task may be determined by the first entity based on the configuration information of the sub-task.

In a possible implementation, the paging message includes a first cause cause value, and the first cause value indicates the type of the sub-task.

In other words, the first entity may add, to the paging message, the first cause value indicating the type of the sub-task, and send, to the terminal device, the paging information that carries the first cause value.

If the service requirement is the requirement of the mobile originated service, the prompt message does not need to include the prompt message, and may carry only the first cause value, and a signaling link establishment principle is the same as that of the requirement of the mobile terminated service. Details are not described herein again.

S02: The first entity receives a radio resource control establishment request message fed back by the terminal device based on the paging message.

If the terminal device receives the paging message that carries the first cause value, the terminal device may feed back the radio resource control (Radio Resource Control) establishment request message to the first entity.

S03: The first entity establishes a signaling link with the terminal device based on the radio resource control establishment request message.

In a possible implementation, the radio resource control establishment request message may also carry a second cause paging value. In this case, S03 may include: The first entity determines a link type based on the second cause value, and establishes the signaling link based on the link type.

The link type may be used to represent types of different link established due to different types of sub-tasks, for example, a computing link type corresponding to a sub-task of a computing type, and a perception link type corresponding to a sub-task of a perception type.

It may be learned from the foregoing example that the first cause value indicates the type of the sub-task. In this case, in this step, a link type corresponding to the first cause value may be determined, and a signaling link corresponding to the link type is established based on the second cause value. In other words, different types of sub-tasks may correspond to different signaling links.

In a possible implementation, the signaling link includes a data radio bearer link and/or a signaling radio bearer link.

For example, it may be learned from the second cause value that, if the type of the sub-task is a computing type, a radio resource control signaling link may be established. If the type of the sub-task is a communication type, a data radio bearer DRB link may be established. If the type of the sub-task is a radio access network type, a link between a network device and a core network (for example, may be a core network of LTE, or may be a core network of 5G) may not be established.

An example in which the type of the sub-task is a computing type is used below to describe establishment of the signaling link.

The link between the network device and the core network may not need to be established, the data radio bearer link may not be established, and the signaling radio bearer (Signaling Radio Bearer, SRB) link may be established. The SRB may be a dedicated signaling radio bearer link of the computing type. A radio resource control RRC message may be transmitted by using the signaling radio bearer SRB link, and the SRB includes an SRB0, an SRB1, an SRB2, and the like. The SRB0 may bear radio resource control RRC signaling existing before a radio resource control RRC connection is established, transmit the signaling by using a common control channel (common control channel, CCCH), and use a transmission mode (Transmission Mode, TM) at a radio link control (Radio Link Control, RLC) layer. The SRB1 may bear radio resource control RRC signaling (which may carry some network attached storage (Network Attached Storage, NAS) signaling) and NAS signaling existing before the SRB2 is established, transmit the signaling by using a dedicated control channel (Dedicated Control CHannel, DCCH), and use an auto mode (Auto Mode, AM) at RLC. The SRB2 bears NAS signaling, transmits the signaling by using the dedicated control channel, and uses the AM mode at the RLC layer. In addition, in a possible implementation, a priority may be set for the signaling link, for example, a priority of the SRB2 is lower than a priority of the SRB1. In addition, SRBs of different types (for example, the SRB1 and the SRB2) may be distinguished by using a logical channel identifier. An SRB of the computing type may be a new SRB such as the SRB3.

In a possible implementation, if the first message carries the data channel transmission policy, the method in this embodiment of this application further includes a step of establishing the data channel by the first entity. Specifically, the step of establishing the data channel by the first entity may include establishing a data channel between the second entity and the terminal device.

In a possible implementation, the radio access network further includes a third entity. The third entity may be specifically a processing unit UP of wireless data, and the data channel includes a data channel between the terminal device and the third entity, and further includes a data channel between the third entity and the first entity.

In a possible implementation, the data channel between the third entity and the second entity is used to transmit at least a task execution result fed back by one terminal device.

In other words, the data channel between the third entity and the second entity may be a shared data channel.

S203: The first entity receives a task execution result fed back by the terminal device.

For descriptions of S203, refer to S103. Details are not described herein again.

S204: The first entity sends the task execution result to the second entity.

For descriptions of S204, refer to S104. Details are not described herein again.

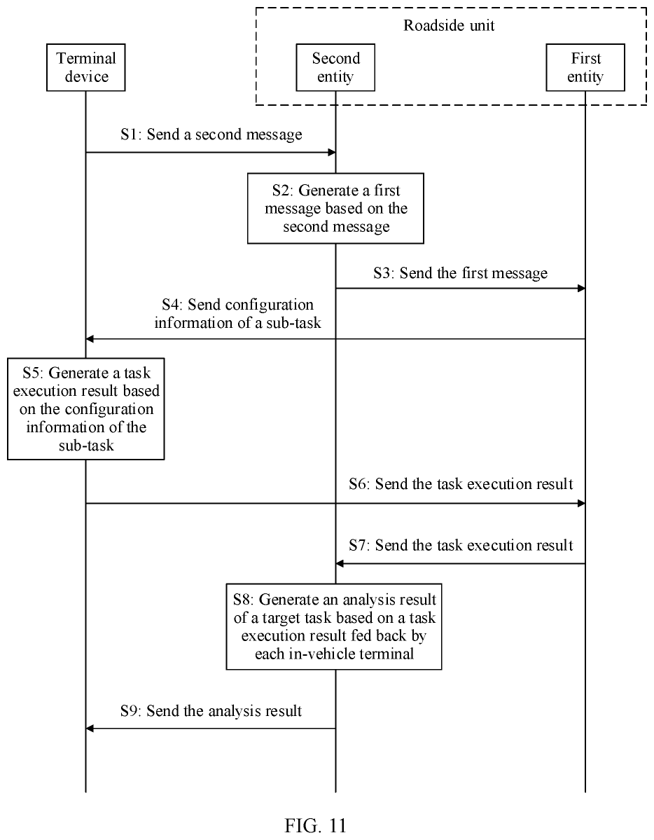

To enable a reader to understand the wireless communication method in embodiments of this application more thoroughly, the wireless communication method in embodiments of this application is described in more detail with reference to FIG. 11. FIG. 11 is a schematic interaction diagram of a wireless communication method according to an embodiment of this application.

As shown in FIG. 11, the method includes the following steps.

S1: A terminal device sends a second message to a second entity, where the second message carries a target task.

Correspondingly, the second entity receives the second message sent by the terminal device.

The terminal device may be an in-vehicle terminal disposed on a vehicle shown in FIG. 1, and when the terminal device is an in-vehicle terminal, the in-vehicle terminal may generate, based on a requirement of obtaining road condition information of a road segment, the second message that carries the target task, and send the second message to the second entity.

In other words, the target task may indicate a service requirement of the in-vehicle terminal, for example, a requirement of obtaining road condition information of a road segment in this embodiment.

A format of the target task may be similar to a format of configuration information of a sub-task. For the format of the target task, refer to the schematic diagram shown in FIG. 8. In addition, the target task may include a type of the task, an identifier of the task, content of the task, and the like.

It should be noted that this embodiment of this application is merely an example to describe content that may be included in the target task, and cannot be understood as a limitation on the target task, for example, the target task may be a requirement of obtaining an electronic map.

In a possible implementation, on the basis of a radio access network that includes a first entity and the second entity, a task center (Task Center) may be further introduced. In addition, the terminal device may communicate with the task center, and the task center may communicate with the second entity. In other words, the terminal device may send the second message to the task center, and the task center sends the second message to the second entity.

In addition, in a possible implementation, the task center may establish a queue mechanism, to control a second message sent by each terminal device (for example, an in-vehicle terminal). For example, a second message received first may be sent to the second entity based on a first in first out policy, or a second message with a high priority may be sent to the second entity based on a priority policy.

S2: The second entity generates a first message based on the second message.

The first message may carry configuration information of a sub-task.

It may be learned from the foregoing example that the configuration information of the sub-task may be used to represent a type of the sub-task. In this case, in this embodiment, the configuration information of the sub-task may be used to represent that the type of the sub-task is a perception type, and the configuration information of the sub-task may be further used to represent content of the sub-task.

Based on the foregoing example, when the method in this embodiment of this application is applied to the application scenario shown in FIG. 1, in this embodiment, the configuration information of the sub-task may be further used to represent that the sub-task is obtaining road condition information in a range of a road segment.

In a possible implementation, the second entity may split the target task based on a type, a size, and the like of the target task to generate configuration information of a plurality of sub-tasks.

For example, in this embodiment, the type of the target task is a perception type. Generally, a priority or a split interval of each type of task may be preferentially set, and the split interval may be used to represent a range between a minimum quantity and a maximum quantity of pieces of configuration information of sub-tasks obtained through splitting. The size of the target task may be used to represent a range of a road segment. Generally, when a coverage area of the road segment is larger, the target task may be relatively split into configuration information of more sub-tasks, to improve efficiency of completing the target task.

In addition, in some other embodiments, the first message may further carry a transmission policy, and the transmission policy may indicate the first entity to transmit the configuration information of the sub-task and/or a task execution result by using a signaling link transmission policy and/or a data channel transmission policy.

One or more policies that are of the signaling link transmission policy and/or the data channel transmission policy and that are specifically used may be set based on a requirement, experience, and a test.

For example, one or two transmission policies may be determined and selected based on attribute information of the target task. It may be learned from the foregoing example that the attribute information of the target task may be used to represent at least one of the type, the size, and a priority of the target task. The size of the target task is used as an example. In this case, when the target task is large, two transmission policies may be used; or when the target task is small, one transmission policy may be used.

S3: The second entity sends the first message to the first entity, and correspondingly, the first entity receives the first message sent by the second entity.

Correspondingly, the first entity receives the first message sent by the second entity.

It may be learned from the foregoing example that there may be one or more first entities, and generally, a correspondence exists between the first entity and the terminal device.

Therefore, in a possible implementation, the second entity may determine and select, based on attribute information of each terminal device, a terminal device that executes the sub-task, and after selecting the terminal device, sends the first message to a first entity corresponding to the selected terminal device.

It may be learned from the foregoing example that the attribute information of the terminal device may include at least running state information and/or location information. In this case, attribute information of the in-vehicle terminal may include at least running state information of the in-vehicle terminal and/or location information of the in-vehicle terminal.

In other words, when the method in this embodiment is applied to the application scenario shown in FIG. 1, this step may specifically include: The second entity selects, from all in-vehicle terminals based on running state information of each in-vehicle terminal and/or location information of the in-vehicle terminal, an in-vehicle terminal that executes the sub-task. Because there are a plurality of pieces of configuration information of sub-tasks, a plurality of in-vehicle terminals are also selected, so that the plurality of in-vehicle terminals jointly complete the target task. In addition, after selecting the plurality of in-vehicle terminals, the second entity sends the configuration information of the sub-tasks to first entities respectively corresponding to the plurality of in-vehicle terminals.

It should be noted that a quantity of sub-tasks executed by the in-vehicle terminal is not limited in this embodiment of this application. In other words, the first entity may send configuration information of one or more sub-tasks to the in-vehicle terminal, and the in-vehicle terminal executes the configuration information of the one or more sub-tasks. In addition, specifically, allocating configuration information of one sub-task or configuration information of a plurality of sub-tasks to the in-vehicle terminal may be determined based on the attribute information of the in-vehicle terminal, or may be determined in a manner such as a requirement and a test. This is not limited in this embodiment of this application.

S4: The first entity sends the configuration information of the sub-task to the terminal device.

Correspondingly, the terminal device receives the configuration information that is of the sub-task and that is sent by the first entity.

In a possible implementation, the configuration information of the sub-task may be sent by using radio resource control information, and specifically, the configuration information of the sub-task may be encapsulated into a radio resource control container (RRC Container).

In a possible implementation, the configuration information of the sub-task may be represented by using different bytes, for example, the configuration information of the sub-task may be represented by using 8 bytes, and the type of the configuration information of the sub-task may be represented by using the first 3 bytes in the 8 bytes.

It may be learned from the foregoing example that, after splitting the target task, the second entity obtains configuration information of a plurality of sub-tasks, and sends the configuration information of the plurality of sub-tasks to a plurality of first entities. For a clear understanding of the solutions of this embodiment of this application, in this embodiment, only an execution process of configuration information of a sub-task is described, that is, a first entity is used as an example for description.

It may be learned from the foregoing example that a terminal device that executes a sub-task may be the terminal device that sends the second message to the second entity. Therefore, that the method in this embodiment is applied to the application scenario shown in FIG. 1 and the in-vehicle terminal that sends the second message and the in-vehicle terminal that executes the sub-task are a same in-vehicle terminal is used as an example for description.

It may be learned from the foregoing example that the first message may further carry a signaling link transmission policy and/or a data channel transmission policy. Therefore, in this step, the second entity may send the configuration information of the sub-task to the in-vehicle terminal based on the signaling link transmission policy and/or the data channel transmission policy.

For construction of a signaling link and/or a data channel, refer to the foregoing example. Details are not described herein again.

S5: The terminal device generates a task execution result based on the configuration information of the sub-task.

Based on the foregoing example, when the method in this embodiment of this application is applied to the application scenario shown in FIG. 1, the target task is collecting road condition information of a road segment A, and the second entity splits the task into configuration information of three sub-tasks. The configuration information of the three sub-tasks is separately collecting road condition information of a road segment A1, collecting road condition information of a road segment A2, and collecting road condition information of a road segment A3. The configuration information that is of the sub-task and that is obtained by the in-vehicle terminal is collecting the road condition information of the road segment A1. In this case, the in-vehicle terminal collects the road condition information of the road segment A1. Correspondingly, the road condition information of the road segment A1 is the task execution result of the in-vehicle terminal.

S6: The terminal device sends the task execution result to the first entity, and correspondingly, the terminal device receives the task execution result sent by the first entity.

Correspondingly, the first entity receives the task execution result sent by the terminal device.

It may be learned from the foregoing example that the terminal device may send the task execution result to the first entity based on the signaling link transmission policy and/or the data channel transmission policy.

In a possible implementation, the terminal device may also send the task execution result to the second entity.

S7: The first entity sends the task execution result to the second entity.

Correspondingly, the second entity receives the task execution result sent by the first entity.

S8: The second entity generates an analysis result of the target task based on a task execution result fed back by each in-vehicle terminal.

It may be learned from the foregoing example that the second entity splits the target task into configuration information of a plurality of sub-tasks, so that a plurality of terminal devices respectively complete the configuration information of the sub-tasks. Therefore, the task execution result received by the second entity is the task execution result fed back by each terminal device, and the second entity performs summarization and analysis on the plurality of task execution results fed back by the terminal devices, to generate the analysis result.

For example, based on the foregoing example, when the method in this embodiment of this application is applied to the application scenario shown in FIG. 1, the second entity receives the road condition information of the road segment A1, the road condition information of the road segment A2, and the road condition information of the road segment A3, and generates the road condition information of the road segment A based on the road condition information of the road segment A1, the road condition information of the road segment A2, and the road condition information of the road segment A3.

A specific process of performing summarization and analysis by the second entity is not limited in this embodiment of this application. For example, the second entity may perform combination processing on the task execution results, or may generate the analysis result after performing preprocessing on each task execution result, for example, screening and filtering.

S9: The second entity sends the analysis result to the terminal device.

Correspondingly, the terminal device receives the analysis result sent by the second entity.

Specifically, the second entity may send the analysis result to the terminal device based on the signaling link transmission policy and/or the data channel transmission policy.

It should be noted that, in a possible implementation, after receiving each task execution result, the second entity may feed back each task execution result to the terminal device, and the terminal device generates the analysis result based on each task execution result.

According to another aspect of embodiments of this application, an embodiment of this application further provides a wireless communication method, and the method may be applied to a second entity.

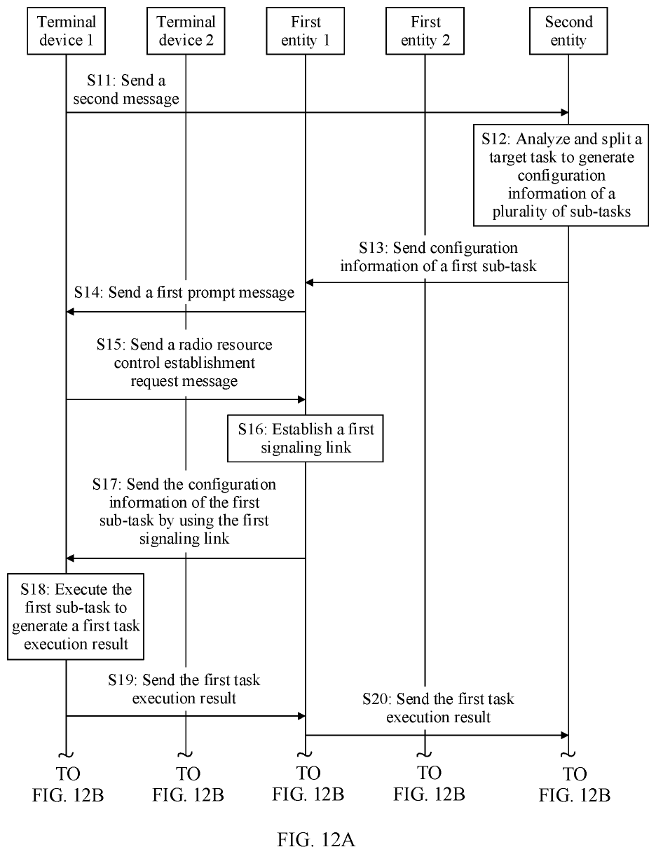

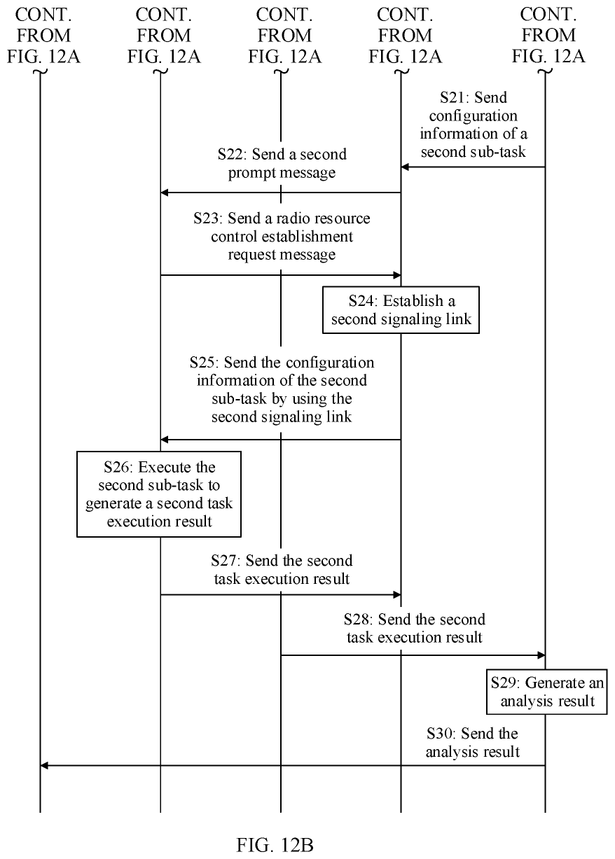

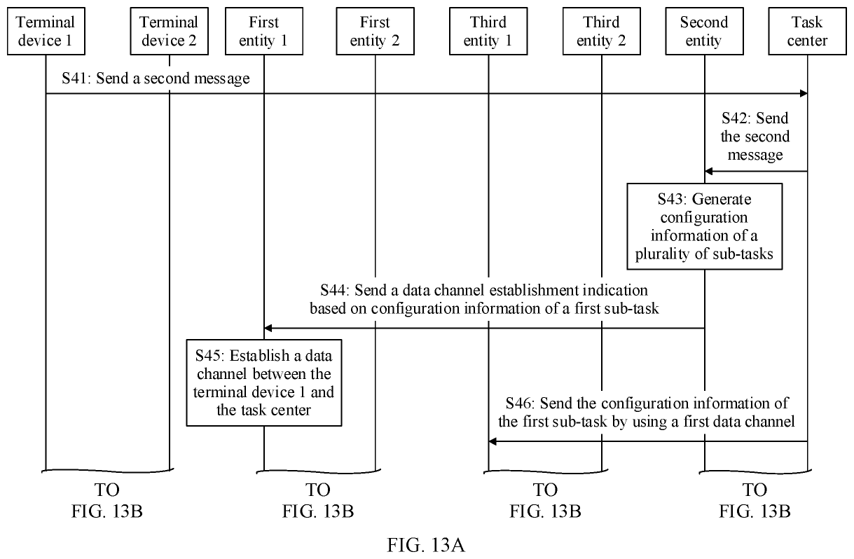

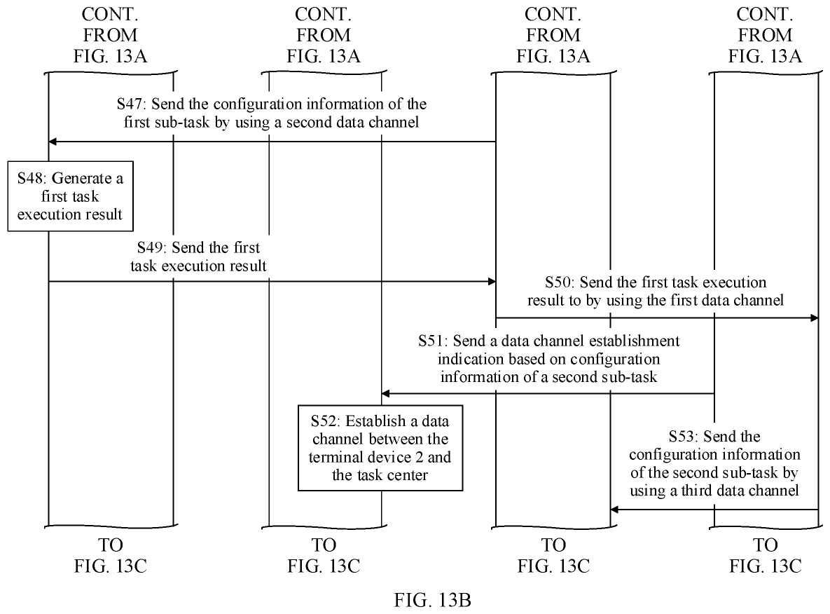

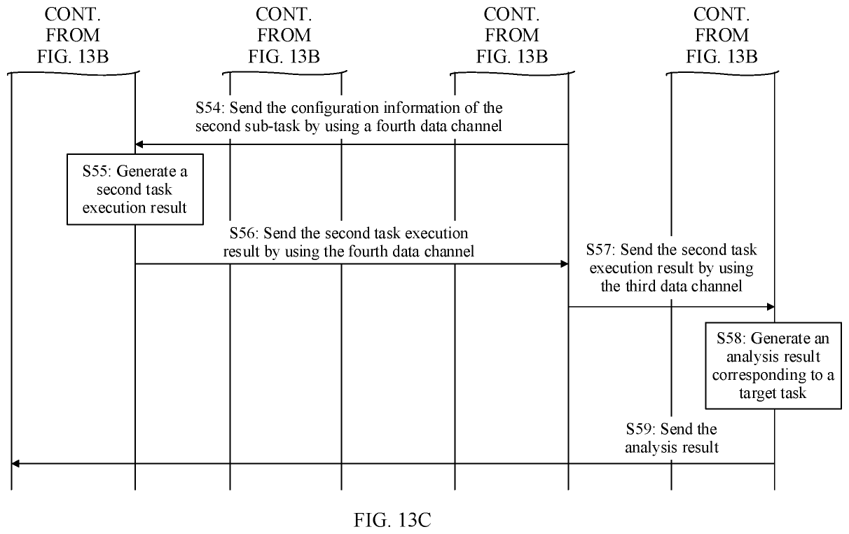

It may be learned from the foregoing example that the wireless communication method in this embodiment of this application may be implemented based on at least two different transmission policies. In addition, it may be learned from a radio access network provided in this embodiment of this application that the transmission policy may be classified into at least a control plane transmission policy and a user plane transmission policy. The control plane transmission policy may be understood as a signaling channel transmission policy in the foregoing example, and the user plane transmission policy may be understood as a data link transmission policy in the foregoing example. A wireless communication method in which a transmission policy is included is described in detail with reference to FIG. 12A to FIG. 13C.

FIG. 12A and FIG. 12B are a schematic interaction diagram of a wireless communication method in which a signaling link transmission policy is included. UE is a terminal device, and the UE includes UE1 and UE2. A U-CP is a first entity, and the U-CP includes a U-CP1 and a U-CP2. A T-CP is a second entity.

As shown in FIG. 12A and FIG. 12B, the method includes the following steps.

S11: The UE1 sends a second message to the T-CP, where the second message carries a target task.

Correspondingly, the T-CP receives the second message sent by the UE1.

S12: The T-CP analyzes and splits the target task to generate configuration information of a plurality of sub-tasks.

For a method for generating the configuration information of the plurality of sub-tasks by the T-CP, refer to the foregoing example. Details are not described herein again.

In addition, in this embodiment of this application, the T-CP analyzes and splits the target task to generate configuration information of two sub-tasks: configuration information of a first sub-task and configuration information of a second sub-task.

S13: The T-CP sends the configuration information of the first sub-task to the U-CP1.

Correspondingly, the U-CP1 receives the configuration information that is of the first sub-task and that is sent by the T-CP.

S14: The U-CP1 sends, to the UE1, a prompt message for establishing a radio resource control link. To distinguish the prompt message from a prompt message sent by the U-CP2 to the UE2 below, the prompt message is marked as a first prompt message, and the first prompt message includes a paging message.

Correspondingly, the UE1 receives the prompt message that is for establishing a radio resource control link and that is sent by the U-CP1.

S15: The UE1 sends a radio resource control establishment request message to the U-CP1, where the radio resource control establishment request message carries a second cause value.

Correspondingly, the U-CP1 receives the radio resource control establishment request message sent by the UE1.

It may be learned from the foregoing example that the paging message may carry a first cause value, the first cause value is used to represent a type of a sub-task, and the second cause value is used to represent a type of a signaling link. For specific descriptions, refer to the foregoing example. Details are not described herein again.

In other words, in this embodiment of this application, the UE1 may determine, based on the paging message, a type of a sub-task to be executed by the UE1, may add the second cause value to the radio resource control establishment request message based on the type of the sub-task that the UE1 needs to execute, to request a type of a signaling link that needs to be established, and may determine the second cause value based on the type of the sub-task or attribute information of the UE1.

S16: The U-CP1 establishes a signaling link between the U-CP1 and the UE1 based on the second cause value. To distinguish the signaling link from a signaling link established below, the signaling link is marked as a first signaling link.

S17: The U-CP1 sends the configuration information of the first sub-task to the UE1 by using the first signaling link.

Correspondingly, the UE1 receives the configuration information that is of the first sub-task and that is sent by the U-CP1 by using the first signaling link.

S18: The UE1 executes the first sub-task based on the configuration information of the first sub-task to generate a task execution result. To distinguish the task execution result from a task execution result obtained by the UE2 by executing the second sub-task below, the task execution result is marked as a first task execution result.

S19: The UE1 sends the first task execution result to the U-CP1. Specifically, the UE1 may send the first task execution result based on the first signaling link.

Correspondingly, the U-CP1 receives the first task execution result sent by the UE1.

S20: The U-CP1 sends the first task execution result to the T-CP.

Correspondingly, the T-CP receives the first task execution result sent by the U-CP1.

S21: The T-CP sends the configuration information of the second sub-task to the U-CP2.

Correspondingly, the U-CP2 receives the configuration information that is of the second sub-task and that is sent by the T-CP.

It should be noted that S13 and S21 may be two steps that are performed based on a sequence, or may be two steps that are simultaneously performed. This is not limited in this embodiment of this application.

S22: The U-CP2 sends, to the UE2, a prompt message for establishing a radio resource control link. To distinguish the prompt message from the foregoing prompt message, the prompt message is marked as a second prompt message.

Based on the foregoing example, a signaling link may be established based on a service requirement (for example, a requirement of a mobile originated service or a mobile terminated service). Therefore, in this embodiment of this application, that the link is established based on two service requirements is described by using an example. To be specific, in S14, the U-CP1 processes the requirement of the mobile terminated service. Therefore, the prompt information includes a paging message, and the first cause value is carried by using the paging message. In S22, the U-CP2 processes the requirement of the mobile originated service. Therefore, the prompt information does not include a paging message, and the prompt information directly carries the first cause value.

For application scenarios of the requirement of the mobile originated service and the requirement of the mobile terminated service, refer to a related technology. Details are not described herein again.

S23: The UE2 sends a radio resource control establishment request message to the U-CP2, where the radio resource control establishment request message carries a second cause value.

Correspondingly, the U-CP2 receives the radio resource control establishment request message sent by the UE2.

S24: The U-CP2 establishes a signaling link between the U-CP2 and the UE2 based on the second cause value. To distinguish the signaling link from the foregoing first signaling link, the signaling link is marked as a second signaling link.

S25: The U-CP2 sends the configuration information of the second sub-task to the UE2 by using the second signaling link.

Correspondingly, the UE2 receives the configuration information that is of the second sub-task and that is sent by the U-CP2 by using the second signaling link.

S26: The UE2 executes the second sub-task based on the configuration information of the second sub-task to generate a task execution result. To distinguish the task execution result from the foregoing first task execution result, the task execution result is marked as a second task execution result.

S27: The UE2 sends the second task execution result to the U-CP2. Specifically, the UE2 may send the second task execution result based on the second signaling link.

Correspondingly, the U-CP2 receives the second task execution result sent by the UE2.

S28: The U-CP2 sends the second task execution result to the T-CP.

Correspondingly, the T-CP receives the second task execution result sent by the U-CP2. S29: The T-CP generates, based on the first task execution result and the second task execution result, an analysis result corresponding to the target task.

S30: The T-CP sends the analysis result to the UE1.

Correspondingly, the UE1 receives the analysis result sent by the T-CP.

It should be noted that this example is merely used to describe a possible implementation embodiment of the wireless communication method in this embodiment of this application, and cannot be understood as a limitation on the wireless communication method. In addition, a specific principle of the wireless communication method may be described based on the foregoing example. In this example, to avoid repetition, details are not described again.

FIG. 13A to FIG. 13C are a schematic interaction diagram of a wireless communication method in which a data channel transmission policy is included. UE is a terminal device, and the UE includes UE1 and UE2. A U-CP is a first entity, and the U-CP includes a U-CP1 and a U-CP2. A T-CP is a second entity. A task is a task center. A UP is a third entity, and the UP includes a UP1 and a UP2.

As shown in FIG. 13A to FIG. 13C, the method includes the following steps.

S41: The UE1 sends a second message to the task, where the second message carries a target task.

Correspondingly, the task receives the second message sent by the UE1.

S42: The task sends the second message to the T-CP.

Correspondingly, the T-CP receives the second message sent by the task.

S43: The T-CP analyzes and splits the target task to generate configuration information of a plurality of sub-tasks.

Similarly, the T-CP may analyze and split the target task to generate configuration information of two sub-tasks: configuration information of a first sub-task and configuration information of a second sub-task.

S44: The T-CP sends a data channel establishment indication to the U-CP1 based on the configuration information of the first sub-task.

Correspondingly, the U-CP1 receives the data channel establishment indication sent by the T-CP based on the configuration information of the first sub-task.

S45: The U-CP1 establishes a data channel between the UE1 and the task, where the data channel includes a first data channel between the UE1 and the UP1, and further includes a second data channel between the UP1 and the task.

Similarly, the first data channel and the second data channel in this example are used to be distinguished from a data channel below.

S46: The T-CP sends the configuration information of the first sub-task to the UP1 by using the first data channel.

Correspondingly, the UP1 receives the configuration information that is of the first sub-task and that is sent by the T-CP by using the first data channel.

S47: The UP1 sends the configuration information of the first sub-task to the UE1 by using the second data channel.

Correspondingly, the UE1 receives the configuration information that is of the first sub-task and that is sent by the UP1 by using the second data channel.

S48: The UE1 executes the first sub-task based on the configuration information of the first sub-task to generate a first task execution result.

Similarly, the first task execution result in this example is used to be distinguished from a task execution result below.

S49: The UE1 sends the first task execution result to the UP1 by using the second data channel.

Correspondingly, the UP1 receives the first task execution result sent by the UE1 by using the second data channel.

S50: The UP1 sends the first task execution result to the task by using the first data channel.

Correspondingly, the task receives the first task execution result sent by the UP1 by using the first data channel.

S51: The T-CP sends a data channel establishment indication to the U-CP2 based on the configuration information of the second sub-task.

Correspondingly, the U-CP2 receives the data channel establishment indication sent by the T-CP based on the configuration information of the second sub-task.

Similarly, a sequence of performing S44 and S51 is not limited in this example.

S52: The U-CP2 establishes a data channel between the UE2 and the task, where the data channel includes a third data channel between the UE2 and the UP2, and further includes a fourth data channel between the UP1 and the task.

Similarly, the third data channel and the fourth data channel in this example are used to be distinguished from the foregoing data channel.

S53: The T-CP sends the configuration information of the second sub-task to the UP2 by using the third data channel.

Correspondingly, the UP2 receives the configuration information that is of the second sub-task and that is sent by the T-CP by using the third data channel.

S54: The UP2 sends the configuration information of the second sub-task to the UE2 by using the fourth data channel.

Correspondingly, the UE2 receives the configuration information that is of the second sub-task and that is sent by the UP2 by using the fourth data channel.

S55: The UE2 executes the second sub-task based on the configuration information of the second sub-task to generate a second task execution result.

Similarly, the second task execution result in this example is used to be distinguished from the foregoing task execution result.

S56: The UE2 sends the second task execution result to the UP2 by using the fourth data channel.

Correspondingly, the UP2 receives the second task execution result sent by the UE2 by using the fourth data channel.

S57: The UP2 sends the second task execution result to the task center task by using the third data channel.

Correspondingly, the task center task receives the second task execution result sent by the UP2 by using the third data channel.

S58: The task center task generates, based on the first task execution result and the second task execution result, an analysis result corresponding to the target task.

S59: The task center task sends the analysis result to the UE1.

Correspondingly, the UE1 receives the analysis result sent by the task center task. Similarly, this example is merely used to describe a possible implementation embodiment of the wireless communication method in this embodiment of this application, and cannot be understood as a limitation on the wireless communication method. In addition, a specific principle of the wireless communication method may be described based on the foregoing example. In this example, to avoid repetition, details are not described again.

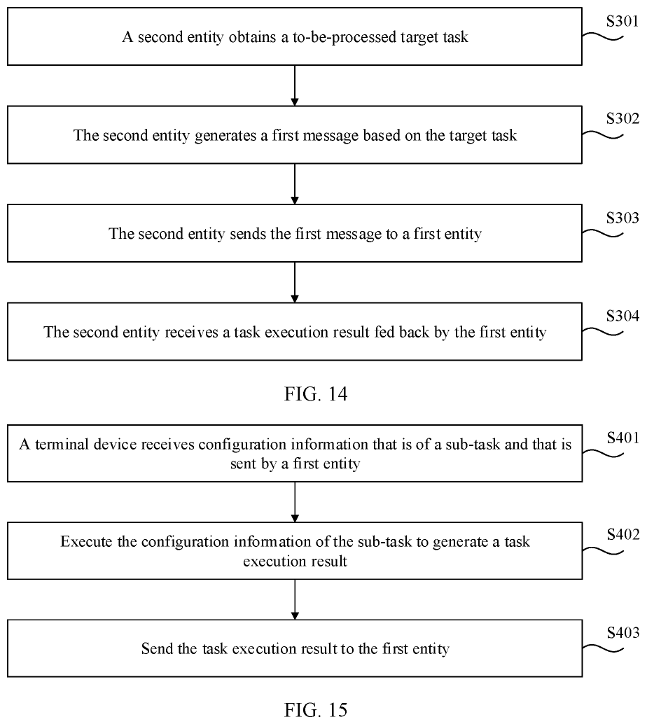

FIG. 14 is a schematic flowchart of a wireless communication method according to another embodiment of this application.

As shown in FIG. 14, the method includes the following steps.

S301: A second entity obtains a to-be-processed target task.

In a possible implementation, a first message is generated by a first entity based on a second message sent by a terminal device, and the second message carries the target task.

S302: The second entity generates the first message based on the target task, where the first message carries configuration information of a sub-task.

In a possible implementation, the first message further carries a signaling link transmission policy and/or a data channel transmission policy.

In a possible implementation, that the first message carries the signaling link transmission policy and/or the data channel transmission policy is determined based on attribute information of the target task.

In a possible implementation, the signaling link transmission policy indicates the first entity to establish a signaling link between the first entity and a terminal device by using a paging message that carries a type of the sub-task. The terminal device and the terminal device that sends the second message are a same terminal device.

In a possible implementation, the paging message includes a first cause value, and the first cause value indicates the type of the sub-task.

In a possible implementation, the signaling link is established by the first entity based on a link type determined based on the first cause value.

In a possible implementation, the signaling link includes a data radio bearer link and/or a signaling radio bearer link.

In a possible implementation, the data channel transmission policy indicates the first entity to establish a data channel between the second entity and the terminal device.

In a possible implementation, the third entity is an entity in a radio access network, and the data channel includes a data channel between the terminal device and the third entity and a data channel between the third entity and the second entity.

In a possible implementation, the data channel between the third entity and the second entity is used to transmit at least a task execution result fed back by the terminal device.

In a possible implementation, the terminal device is selected by the second entity based on attribute information of each terminal device, and the attribute information may include running state information and/or location information.

S303: The second entity sends the first message to the first entity, where the first entity and the second entity are entities in the radio access network.

S304: The second entity receives a task execution result fed back by the first entity.

According to another aspect of embodiments of this application, an embodiment of this application further provides a wireless communication method, and the method may be applied to a terminal device.

FIG. 15 is a schematic flowchart of a wireless communication method according to another embodiment of this application.

As shown in FIG. 15, the method includes the following steps.

S401: The terminal device receives configuration information that is of a sub-task and that is sent by a first entity, where the first entity is an entity in a radio access network.

In a possible implementation, the configuration information of the sub-task is sent by the first entity based on a signaling link transmission policy and/or a data channel transmission policy that are/is carried in a first message.

In a possible implementation, if the first message carries the signaling link transmission policy, the method further includes a step of constructing a signaling link. Specifically, the terminal device receives a paging message sent by the first entity, where the paging message carries a type of the sub-task, generates a radio resource control establishment request message based on the paging message, and establishes a signaling link with the first entity based on the radio resource control establishment request message.

In a possible implementation, that the paging message carries the type of the sub-task includes: The paging message includes a first cause value, and the first cause value indicates the type of the sub-task.

In a possible implementation, the radio resource control establishment request message carries a second cause value.

In a possible implementation, the signaling link includes a data radio bearer link and/or a signaling radio bearer link.

In a possible implementation, if the first message carries the data channel transmission policy, the data channel transmission policy indicates that a data channel that is between the terminal device and a second entity and that is established by the first entity is used to transmit the configuration information of the sub-task and a task execution result, and the second entity is an entity in the radio access network.

In a possible implementation, the data channel includes a data channel between the terminal device and the third entity and a data channel between the third entity and the second entity, and the third entity is an entity in the radio access network.

In a possible implementation, the task execution result and an execution result of another sub-task are transmitted by using the same data channel between the third entity and the second entity.

In a possible implementation, that the first message carries the signaling link transmission policy and/or the data channel transmission policy is determined based on attribute information of a target task.

In a possible implementation, the terminal device is selected by the second entity based on attribute information of each terminal device, and the attribute information may include running state information and/or location information.

In a possible implementation, the first message is generated by the second entity based on a second message sent by the terminal device, and the second message carries the target task.

S402: Execute the sub-task based on the configuration information of the sub-task to generate a task execution result.

S403: Send the task execution result to the first entity.

According to another aspect of embodiments of this application, an embodiment of this application further provides a computer storage medium, where the computer storage medium stores computer instructions, and when the computer instructions are run by a processor, the method in any one of the foregoing embodiments is performed.

According to another aspect of embodiments of this application, an embodiment of this application further provides a user control plane apparatus, where the user control plane apparatus may be the first entity in any one of the foregoing embodiments, and includes a processor, configured to execute computer instructions stored in a memory, and when the computer instructions are executed, the user control plane apparatus is enabled to perform the method applied to the first entity in the foregoing embodiments.

According to another aspect of embodiments of this application, an embodiment of this application further provides a task control plane apparatus, where the task control plane apparatus may be the second entity in any one of the foregoing embodiments, and includes a processor, configured to execute computer instructions stored in a memory, and when the computer instructions are executed, the task control plane apparatus is enabled to perform the method applied to the second entity in the foregoing embodiments.

According to another aspect of embodiments of this application, an embodiment of this application further provides a terminal device, including a processor, configured to execute computer instructions stored in a memory, where when the computer instructions are executed, the terminal device is enabled to perform the method applied to the terminal device in the foregoing embodiments.

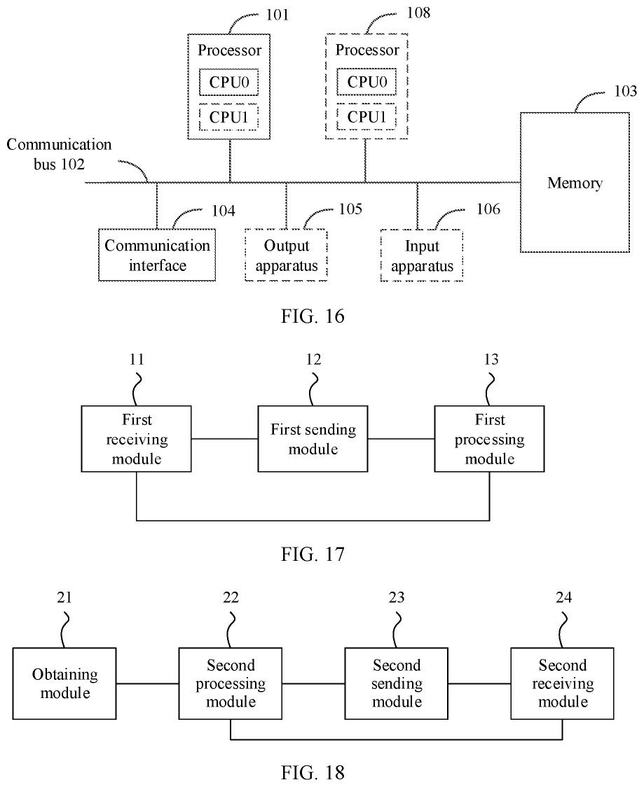

FIG. 16 is a block diagram of a terminal device according to an embodiment of this application.

The terminal device includes at least one processor 101, a communication bus 102, a memory 103, and at least one communication interface 104. The terminal device may be a general-purpose computer or server, or may be a special-purpose computer or server.

The processor 101 may be a central processing unit (central processing unit, CPU), a microprocessor, an application-specific integrated circuit (application-specific integrated circuit, ASIC), a digital signal processor (digital signal processor, DSP), a field programmable gate array (field programmable gate array, FPGA), a discrete gate or a transistor logic device, a discrete hardware component, or one or more integrated circuits configured to control program execution of the solutions of this application.

The communication bus 102 may include a channel that transmits information between the foregoing components (for example, between the processor and the memory).

The communication interface 104 may be an internet protocol (Internet Protocol, IP) port or a bus interface between any transceivers or networks, and is configured to communicate with an internal or external device or apparatus or a communication network, for example, the Ethernet, a radio access network, and a wireless local area network (wireless local area networks, WLAN). For example, when the terminal device is a functional unit integrated into a vehicle, the communication interface 104 includes one or more of the following interfaces, for example, a transceiver that communicates with an external network of the vehicle and a bus interface (such as a controller area network (Controller Area Network, CAN) bus interface) that communicates with another internal unit of the vehicle.

The memory 103 may be a read-only memory (read-only memory, ROM) or another type of static storage device that can store static information and instructions, or a random access memory (random access memory, RAM) or another type of dynamic storage device that can store information and instructions, or may be an electrically erasable programmable read-only memory (electrically erasable programmable read-only memory, EEPROM), a compact disc read-only memory (compact disc read-only memory, CD-ROM) or another optical disk storage, an optical disc storage (including a compact disc, a laser disc, an optical disc, a digital versatile disc, a Blu-ray disc, or the like), a disk storage medium or another magnetic storage device, or any other medium that can be used to carry or store expected program code in a form of instructions or a data structure and that can be accessed by a computer. However, the memory 803 is not limited thereto. The memory may exist independently, and is connected to the processor by using the bus. Alternatively, the memory may be integrated with the processor.

The memory 103 is a computer-readable storage medium provided in this application, and the memory stores instructions that may be executed by at least one processor, so that the at least one processor performs the wireless communication method provided in this application. The computer-readable storage medium in this application stores computer instructions, and the computer instructions are used to enable a computer to perform the wireless communication method provided in this application.

As a computer-readable storage medium, the memory 103 may be configured to store a software program, a computer executable program, and a module. The processor 101 executes various function applications and data processing of a server by running the software program, the instructions, and the module that are stored in the memory 103, to implement the wireless communication method in the foregoing method embodiments.

The memory 103 may include a program storage area and a data storage area. The program storage area may store an operating system and an application program required by at least one function. The data storage area may store data created based on use of the electronic device and the like. In addition, the memory 103 may include a high-speed random access memory, and may further include a non-transitory memory, for example, at least one magnetic disk storage component, a flash memory component, or another non-transitory solid-state storage component. In a possible implementation, the memory 103 optionally includes a memory remotely disposed relative to the processor 101. The remote memory may be connected to the terminal device by using a network. An example of the network includes but is not limited to the internet, the internet of vehicles, the intranet, a local area network, a mobile communication network, and a combination thereof.

During specific implementation, in an embodiment, the processor 101 may include one or more CPUs such as a CPU0 and a CPU1 in FIG. 16.

In a specific implementation, in an embodiment, the terminal device may include a plurality of processors, for example, the processor 101 and a processor 108 in FIG. 16. Each of the processors may be a single-core (single-CPU) processor or a multi-core (multi-CPU) processor. Herein, the processor may be one or more devices, circuits, and/or processing cores configured to process data (for example, computer program instructions).

In a specific implementation, in an embodiment, the terminal device may further include an output apparatus 105 and an input apparatus 106. The output apparatus 105 communicates with the processor 101, and may display information in a plurality of manners. For example, the output apparatus 105 may be a liquid crystal display (liquid crystal display, LCD), a light emitting diode (light emitting diode, LED) display apparatus, a cathode ray tube (cathode ray tube, CRT) display apparatus, or a projector (projector). The input apparatus 106 communicates with the processor 101, and may receive an input of a user in a plurality of manners. For example, the input apparatus 106 may be a mouse, a keyboard, a touchscreen apparatus, or a sensing apparatus.

When the terminal device shown in FIG. 16 is a chip, a function/implementation process of the communication interface 104 may be further implemented by using a pin, an input circuit/output interface, or the like. The memory is a storage unit in the chip, for example, a register or a cache. Alternatively, the storage unit may be a storage unit located outside the chip.

According to another aspect of embodiments of this application, an embodiment of this application further provides a user control plane apparatus.

FIG. 17 is a schematic diagram of a user control plane apparatus according to an embodiment of this application.

As shown in FIG. 17, the user control plane apparatus includes:

a first receiving module 11, configured to receive a first message sent by a second entity, where the first message carries configuration information of a sub-task, and the first entity and the second entity are entities in a radio access network; and a first sending module 12, configured to send the configuration information of the sub-task to a terminal device, where the first receiving module 11 is configured to receive a task execution result fed back by the terminal device; and the first sending module 12 is configured to send the task execution result to the second entity.

In a possible implementation, the first message further carries a signaling link transmission policy and/or a data channel transmission policy, and the first sending module 12 is configured to send the configuration information of the sub-task to the terminal device based on the signaling link transmission policy and/or the data channel transmission policy.

In a possible implementation, if the first message carries the signaling link transmission policy, the user control plane apparatus further includes:

the first sending module 12, configured to send, to the terminal device, a prompt message for establishing a radio resource control link;

the first receiving module 11, configured to receive a radio resource control establishment request message fed back by the terminal device based on the prompt message;

and a first processing module 13, configured to establish a signaling link with the terminal device based on the radio resource control establishment request message.

In a possible implementation, the prompt message includes a paging message that carries a type of the sub-task.

In a possible implementation, the paging message includes a first cause value, and the first cause value indicates the type of the sub-task.

In a possible implementation, the radio resource control establishment request message carries a second cause value, and the first processing module is configured to: determine a link type based on the second cause value, and establish the signaling link based on the link type.

In a possible implementation, the signaling link includes a data radio bearer link and/or a signaling radio bearer link.

In a possible implementation, if the first message carries the data channel transmission policy, the first processing module 13 is configured to establish a data channel between the second entity and the terminal device.

In a possible implementation, the data channel includes a data channel between the terminal device and the third entity and a data channel between the third entity and the second entity, and the third entity is an entity in the radio access network.

In a possible implementation, the data channel between the third entity and the second entity is used to transmit at least the task execution result fed back by the terminal device.

In a possible implementation, the terminal device is selected by the second entity based on attribute information of each terminal device, and the attribute information may include running state information and/or location information.

In a possible implementation, the first message is generated by the second entity based on a second message sent by the terminal device, and the second message carries a target task.

In a possible implementation, that the first message carries the signaling link transmission policy and/or the data channel transmission policy is determined by the second entity based on attribute information of the target task.

According to another aspect of embodiments of this application, an embodiment of this application further provides a task control plane apparatus.

FIG. 18 is a schematic diagram of a task control plane apparatus according to an embodiment of this application.

As shown in FIG. 18, the task control plane apparatus includes:

an obtaining module 21, configured to obtain a to-be-processed target task;

a second processing module 22, configured to generate a first message based on the target task, where the first message carries configuration information of a sub-task;

a second sending module 23, configured to send the first message to a first entity, where the first entity and the second entity are entities in a radio access network; and

a second receiving module 24, configured to receive a task execution result fed back by the first entity.

In a possible implementation, the first message further carries a signaling link transmission policy and/or a data channel transmission policy.

In a possible implementation, the signaling link transmission policy indicates the first entity to establish a signaling link between the first entity and a terminal device based on a prompt message of a radio resource control link.

In a possible implementation, the prompt message includes a paging message that carries a type of the sub-task.

In a possible implementation, the paging message includes a first cause value, and the first cause value indicates the type of the sub-task.

In a possible implementation, the signaling link is established by the first entity based on a link type determined based on a second cause value.

In a possible implementation, the signaling link includes a data radio bearer link and/or a signaling radio bearer link.

In a possible implementation, the data channel transmission policy indicates the first entity to establish a data channel between the second entity and the terminal device.

In a possible implementation, the data channel includes a data channel between the terminal device and the third entity and a data channel between the third entity and the second entity, and the third entity is an entity in the radio access network.

In a possible implementation, the data channel between the third entity and the second entity is used to transmit at least the task execution result fed back by the terminal device.

In a possible implementation, the terminal device is selected by the second entity based on attribute information of each terminal device, and the attribute information may include running state information and/or location information.

In a possible implementation, the first message is generated by the first entity based on a second message sent by the terminal device, and the second message carries the target task.

In a possible implementation, that the first message carries the signaling link transmission policy and/or the data channel transmission policy is determined based on attribute information of the target task.

According to another aspect of embodiments of this application, an embodiment of this application further provides a terminal device.

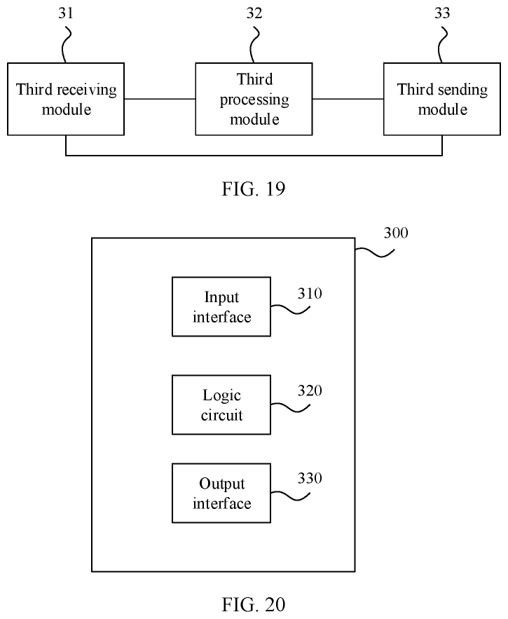

FIG. 19 is a schematic diagram of a terminal device according to an embodiment of this application.

As shown in FIG. 19, the terminal device includes:

a third receiving module 31, configured to receive configuration information that is of a sub-task and that is sent by a first entity, where the first entity is an entity in a radio access network;

a third processing module 32, configured to execute the sub-task based on the configuration information of the sub-task to generate a task execution result; and

a third sending module 33, configured to send the task execution result to the first entity.

In a possible implementation, the configuration information of the sub-task is sent by the first entity based on a signaling link transmission policy and/or a data channel transmission policy that are/is carried in a first message.

In a possible implementation, if the first message carries the signaling link transmission policy, the third receiving module 31 is configured to receive a prompt message that is for establishing a radio resource control link and that is sent by the first entity; and the third processing module 32 is configured to: generate a radio resource control establishment request message based on the prompt message, and establish a signaling link with the first entity based on the radio resource control establishment request message.

In a possible implementation, the prompt message includes a paging message that carries a type of the sub-task.

In a possible implementation, the paging message includes a first cause value, and the first cause value indicates the type of the sub-task.

In a possible implementation, the radio resource control establishment request message carries a second cause value.

In a possible implementation, the signaling link includes a data radio bearer link and/or a signaling radio bearer link.

In a possible implementation, if the first message carries the data channel transmission policy, the data channel transmission policy indicates that a data channel that is between the terminal device and a second entity and that is established by the first entity is used to transmit the configuration information of the sub-task and the task execution result, and the second entity is an entity in the radio access network.

In a possible implementation, the data channel includes a data channel between the terminal device and the third entity and a data channel between the third entity and the second entity, and the third entity is an entity in the radio access network.

In a possible implementation, the task execution result and an execution result of another sub-task are transmitted by using the same data channel between the third entity and the second entity.

In a possible implementation, the terminal device is selected by the second entity based on attribute information of each terminal device, and the attribute information may include running state information and/or location information.

In a possible implementation, the first message is generated by the second entity based on a second message sent by the terminal device, and the second message carries a target task.

In a possible implementation, that the first message carries the signaling link transmission policy and/or the data channel transmission policy is determined based on attribute information of the target task.

According to another aspect of embodiments of this application, an embodiment of this application further provides a radio access network device, including a central unit and a distribution unit, and further including:

the user control plane apparatus described in the foregoing embodiments, for example, the user control plane apparatus shown in FIG. 17; and

the task control plane apparatus described in the foregoing embodiments, for example, the task control plane apparatus shown in FIG. 18.

According to another aspect of embodiments of this application, an embodiment of this application further provides a wireless communication system, where the system includes:

the radio access network device described in the foregoing embodiments, for example, a radio access network device to which the user control plane apparatus shown in FIG. 17 and the task control plane apparatus shown in FIG. 18 are introduced; and the terminal device described in the foregoing embodiments, for example, the terminal device shown in FIG. 16 or FIG. 19.

According to another aspect of embodiments of this application, an embodiment of this application further provides an apparatus.

FIG. 20 is a schematic diagram of an apparatus 300 according to an embodiment of this application. The apparatus 300 may be configured to perform the method performed by the terminal device or the network device, and the apparatus 300 may be a communication device or a chip in the communication device.

As shown in FIG. 20, the apparatus 300 includes at least one input interface (Input(s)) 310, a logic circuit 320, and at least one output interface (Output(s)) 330. The input interface may also be an input circuit, and the output interface may also be an output circuit. Optionally, the foregoing logic circuit 320 may be a chip or another integrated circuit that may implement the method in this application.

The logic circuit 320 may implement the method performed by the terminal device or the network device in the foregoing embodiments.

The input interface 320 is configured to receive data. The output interface 330 is configured to send data. For example, when the apparatus 300 is a terminal device, the input interface 310 may be configured to receive configuration information that is of a sub-task and that is sent by the network device, and the input interface 310 may be further configured to receive an RRC message sent by the network device. The output interface 310 may be configured to send, to the network device, a second message that carries a target task. When the apparatus 300 is a network device, the output interface 330 is configured to deliver configuration information of a sub-task to the terminal device, and the output interface may be further configured to deliver an RRC message to the terminal device. The input interface 310 may be configured to receive a second message that is sent by the terminal device and that carries a target task.

For a function of the input interface 310, the logic circuit 320, or the output interface 330, refer to the method performed by the terminal device or the network device in the foregoing embodiments. Details are not described herein again.

According to another aspect of embodiments of this application, an embodiment of this application further provides a computer program product, where when the computer program product runs on a processor, the method in any one of the foregoing embodiments is performed.

It should be understood that steps may be reordered, added, or deleted by using the foregoing various forms of processes. For example, steps described in this application may be performed in parallel, may be performed sequentially, or may be performed based on different sequences, provided that a desired result of the technical solutions of this application can be implemented. This is not limited herein.

The foregoing specific implementation does not constitute a limitation on the protection scope of this application. A person skilled in the art should understand that various modifications, combinations, sub-combinations, and substitutions can be made based on a design requirement and another factor. Any modification, equivalent replacement, and improvement made without departing from the spirit and principle of this application shall fall within the protection scope of this application.

What is claimed is:

1. A wireless communication method, wherein the method is applied to a terminal device, and the method comprises:
receiving configuration information that is of a sub-task and that is sent by a first entity, wherein the first entity is an entity in a radio access network;
executing the sub-task based on the configuration information of the sub-task to generate a task execution result; and
sending the task execution result to the first entity.

2. The method according to claim 1, wherein the configuration information of the sub-task is sent by the first entity based on a signaling link transmission policy and/or a data channel transmission policy that are/is carried in a first message.

3. The method according to claim 2, wherein if the first message carries the signaling link transmission policy, the method further comprises:
receiving a prompt message that is for establishing a radio resource control link and that is sent by the first entity;
generating a radio resource control establishment request message based on the prompt message; and
establishing a signaling link with the first entity based on the radio resource control establishment request message.

4. The method according to claim 3, wherein the prompt message comprises a paging message that carries a type of the sub-task.

5. The method according to claim 4, wherein the paging message comprises a first cause value, and the first cause value indicates the type of the sub-task.

6. The method according to claim 4, wherein the radio resource control establishment request message carries a second cause value.

7. The method according to claim 3, wherein the signaling link comprises a data radio bearer link and/or a signaling radio bearer link.

8. The method according to claim 2, wherein if the first message carries the data channel transmission policy, the data channel transmission policy indicates that a data channel that is between the terminal device and a second entity and that is established by the first entity is used to transmit the configuration information of the sub-task and the task execution result, and the second entity is an entity in the radio access network.

9. The method according to claim 8, wherein the data channel comprises a second data channel between the terminal device and a third entity and a first data channel between the third entity and the second entity, and the third entity is an entity in the radio access network.

10. The method according to claim 9, wherein the task execution result and an execution result of another sub-task are transmitted by using the same first data channel between the third entity and the second entity.

11. The method according to claim 9, wherein the second data channel is a data radio bearer link.

12. The method according to claim 8, wherein the terminal device is selected by the second entity based on attribute information of each terminal device, and the attribute information comprises running state information and/or location information.

13. The method according to claim 8, wherein the first message is generated by the second entity based on a second message sent by the terminal device, and the second message carries a target task.

14. The method according to claim 13, wherein that the first message carries the signaling link transmission policy and/or the data channel transmission policy is determined based on attribute information of the target task.

15. A terminal device, wherein the terminal device comprises:
a third receiving module, configured to receive configuration information that is of a sub-task and that is sent by a first entity, wherein the first entity is an entity in a radio access network;
a third processing module, configured to execute the sub-task based on the configuration information of the sub-task to generate a task execution result; and
a third sending module, configured to send the task execution result to the first entity.

16. The terminal device according to claim 15, wherein the configuration information of the sub-task is sent by the first entity based on a signaling link transmission policy and/or a data channel transmission policy that are/is carried in a first message.

17. The terminal device according to claim 16, wherein if the first message carries the signaling link transmission policy, the third receiving module is configured to receive a prompt message that is for establishing a radio resource control link and that is sent by the first entity; and
the third processing module is configured to: generate a radio resource control establishment request message based on the prompt message, and establish a signaling link with the first entity based on the radio resource control establishment request message.

18. The terminal device according to claim 17, wherein the prompt message comprises a paging message that carries a type of the sub-task.

19. The terminal device according to claim 18, wherein the paging message comprises a first cause value, and the first cause value indicates the type of the sub-task.

20. A computer program product, the computer program product comprising processor executable instructions stored on non-transitory computer readable media, wherein the processor executable instructions, when executed by a processor, cause the processor to carry out the method according to claim 1.
